(19) United States
(12) Patent Application Publication
(10) Pub. No.: US 2005/0021540 A1
(43) Pub. Date: Jan. 27, 2005

(54) System and method for a rules based engine

(75) Inventors: Timothy P. McKee, Seattle, WA (US); Michael P. Arcuri, Seattle, WA (US); Chaitanya D. Sareen, Seattle, WA (US); Lyon K.F. Wong, Issaquah, WA (US); Praveen Seshadri, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/837,512

(22) Filed: Apr. 30, 2004

Related U.S. Application Data
(63) Continuation-in-part of application No. 10/809,249, filed on Mar. 25, 2004.
Application No. 10/809,249 is a continuation-in-part of application No. 10/692,324, filed on Oct. 23, 2003.
Application No. 10/692,324 is a continuation-in-part of application No. 10/402,075, filed on Mar. 26, 2003.

(51) Int. Cl. G06F 17/00

(52) U.S. Cl. 707/100

(57) ABSTRACT

A system and method for a rules based engine which allows a user to act on and set rules with regard to data items. Known rules engines have typically only been applied to single item types (e.g., e-mail). The rules engine of the present invention provides a user with a way to build up sets of items from within a common store of items, and to develop common actions on items conforming to the sets. The common store of items may include different types of items, such as e-mails, documents, items constructed for arbitrary business workflow, etc. The invention allows a user to automate business practices or work flows (e.g., “notify me when items like this appear” and/or “automatically back up these types of items to my server”).

### CROSS-REFERENCES TO RELATED APPLICATIONS

This application is a continuation-in-part of U.S. patent application Ser. No. 10/809,249, filed Mar. 25, 2004, which is a continuation-in-part of U.S. patent application Ser. No. 10/692,324, filed Oct. 23, 2003, which is a continuation-in-part of U.S. patent application Ser. No. 10/402,075, filed Mar. 26, 2003, each of which is hereby incorporated by reference in its entirety, and priority from the filing dates of which is hereby claimed under 35 U.S.C. § 120.

### FIELD OF THE INVENTION

The embodiment of the present invention relates to a system and method for a rules engine that allows a user to act on and set rules with regard to data items.

### BACKGROUND OF THE INVENTION

In certain known systems, “rules engines” have been created for a variety of end-user activities. For example, Microsoft Outlook® has “inbox rules” that allow a user to specify a variety of actions to occur upon the reception of a given e-mail, based on characteristics of that e-mail, such as the sender or the subject line (e.g., forwarding e-mails from selected senders). However, these known systems have only been applied to single item types (e.g., e-mail).

Other known systems of different types currently require users to perform multiple manual tasks in order to complete a work flow process. For example, in a typical office system, a process for a user to review and approve expense reports might require the following steps. First, the expense reports might be e-mailed to a required reviewer for approval, or the expense reports might be placed on a commonly accessible server share. Then, the approver would need to be notified in some way that a report had come in which needed to be approved, after which the approver would need to find the report, make whatever actions are needed on it, and then remember how to move the report to its final processing point. All of these steps are fairly burdensome to a user.

The embodiment of the present invention is related to providing a system and method that overcome the foregoing and other disadvantages. More specifically, the embodiment of the present invention is related to a system and method for a rules engine that allows a user to act on and set rules with regard to data items.

### SUMMARY OF THE INVENTION

A system and method for a rules engine are provided. In accordance with one aspect of the invention, the rules engine allows a user to act on and set rules with regard to any data item. In one embodiment, the data items may be of different types and may be contained in a database (e.g. a relational database). Rules engines in known systems have only typically been applied to a single item type (e.g., e-mail). The rules engine of the present invention provides users with mechanisms for building up sets of items from within a common store of items (which may include different item types), and which also provides users with mechanisms for developing common actions on items conforming to the sets. Once the data sets have been created, the end-user can set up rules to act on items conforming to these sets, so as to automate business processes or work flows (e.g., “notify me when items like this appear” or “automatically back up these types of items to my server”).

In accordance with another aspect of the invention, the rules engine may be utilized to allow the end-user, through inspecting the items within a database, to construct arbitrarily complex queries. For example, a query such as “all items by (Tim or Mike)” is a query that the user can construct by inspecting the items in the database and seeing that two of the possible item authors are Tim and Mike. A multitude of mechanisms may be utilized for presenting this information through a user interface; however, in one embodiment the execution of the query returns a virtual folder containing all items—including e-mails, word documents, items constructed for arbitrary business work flows, etc.—all marked as having been authored by Tim or Mike. If the user does not have a fully desired data set at this point, additional parameters can be applied to the query definition to further refine the query set. Any type of logical or mathematical operations may be utilized (e.g., and, or, not, xor, =, >, <, contains, etc.), and can be applied to the conditions in the query to make the exact data set that is desired for whatever logical, work flow, or business reasons the end-user may require. In the above scenario, the rules engine is utilized to construct a data set with the default action “show me this set.” The user can save this query definition such that at any time subsequently, it can be rematerialized against the current state of the database showing those items that match this data set definition at that point in time.

In accordance with another aspect of the invention, the rules engine may also be utilized for helping a user stay on top of a set of data as part of a day-to-day work flow. In one example, a user who is required to review and approve expense reports may implement daily tasks, including looking at items conforming to a particular complex query set (e.g., item type=“expense report” where submitter=[one of my reports]), changing properties on these items (e.g., setting status=“approved”), and then moving the item to a common clearing place (e.g., a central server where approved expense reports are processed). For the first step of looking for the expense reports, the user is able to make a query to represent the expense reports needing approval. It will be appreciated that this query will work against all items, whether the route that the report arrived was through e-mail or through the copying of the report to a common file share, since all items in the database are peers and the actual transport is irrelevant. It will also be appreciated that the query item used (item type=“expense report” where submitter=[one of my reports]) is actually a query with a sub-query. This can be used because the rules engine is able to consume its own queries as re-usable elements in other queries. In this particular case, the reviewer constructed the query to represent people in the directory who reported to himself, which then was re-used to join these individuals against a submitted expense report.

In accordance with another aspect of the invention, the rules engine can also define a rule to look for new items conforming to a particular data set and to send the user a notification when a new item conforming to the set appears. In the above example, the user is able to set up a personal alert that is to be sent when a new expense report has appeared. In one embodiment, this is represented by a notification that is sent to the user's screen that indicates that a report has appeared (regardless of whether the report appeared from an e-mail or whatever other transport mechanism it was moved into the database). It will be appreciated that a variety of other methods can also be utilized for notifying the user.

In accordance with another aspect of the invention, the rules engine may also define rules that determine the appropriate timing for certain actions (e.g., the timing for delivering a notification to a user). For example, when the notification is generated, the user may be in the middle of a presentation to management. The rules engine may have rules to not show a notification during a full screen presentation, as this indicates that the user is most likely busy. In this particular example, an expense report appears and a call is made to the notification rules within the rules engine. These rules process and determine that it is not an appropriate time to show the notification (as this would distract from the full screen presentation) and so the notification is held until an appropriate time. After the presentation is finished, it is determined that the time is appropriate and the approver receives a notification that the new expense report needs approval. The user is able to click on the notification which materializes the data set for the approver (invoking the persisted query) and the approval process can be started.

In accordance with another aspect of the invention, the user may create additional rules to further automate the work flow process. In the above example, just as the user is able to set up a rule to notify when an item conforming to a desired set appears, the user can also go through the same process to set up another rule such that expense reports marked “approved” are automatically moved to a central server location. The process of setting up this additional rule can be similar to the process for setting up the original rule, including constructing a query representing the desired set (in this case expense reports marked “approved”) and then adding an action to it (“move to central server”). Once this additional rule has been created, the overall process can proceed in the following manner: an expense report appears; at an appropriate time (e.g., when the user is not busy such as giving a presentation), a notification appears; the approver clicks on the notification to see the set of expense reports needing approval; as each expense report is marked “approved,” it is transferred to the central server for final processing. It will be appreciated that the previous manual steps for this process can thus be automated through the user's creation of two rules.

In accordance with another aspect of the invention, a number of base operations may be provided from which a user may select for creating new rules. Such base operations may include: notify me; copy; move; add; remove; delete; create relationship; set property; etc. With regard to the “add” and “remove” elements, these may be utilized for purposes of adding an additional reference to an item in a specific list. The user may have a shared list, and any time an item of a given nature appears, it may be automatically added to the list and thus shared. It will be appreciated that this is an effective means for ensuring that all files pertaining to a given project are shared with specific team members.

In accordance with another aspect of the invention, in the rules engine the actions that can be taken are arbitrarily extensible by third parties who want to extend the system. In one example, an e-mail program may wish to add a “send mail” action to the system. This would allow users to set up rules to send mail to themselves and to others that they collaborate with when various items conforming to queries appeared on the system.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a general purpose computer system suitable for implementing the embodiment of the present invention;

FIG. 2 is a flow diagram illustrative of a general routine for processing a notification in accordance with the embodiment of the present invention;

FIG. 3 is a flow diagram illustrative of a routine for an operating system or arbitrary program declaring user contexts;

FIG. 4 is a flow diagram illustrative of a routine for evaluating user contexts as true or false at the time a notification API is called;

FIG. 5 is a flow diagram illustrative of a routine for adjusting user contexts and creating new user rules;

FIG. 6 is a flow diagram illustrative of a routine for processing a notification in accordance with user contexts and user rules;

FIG. 7 is a flow diagram illustrative of a routine for implementing user rules based on a notification's content and the user contexts;

FIG. 8 is a flow diagram illustrative of a routine for deferring the delivery of a notification;

FIG. 9 is a flow diagram illustrative of a routine for determining how a notification will be drawn in accordance with various restrictive settings;

FIG. 10 is a flow diagram illustrative of a routine for determining a volume level for a notification in accordance with various restrictive settings;

FIG. 11 is a flow diagram illustrative of a general routine for processing a test notification in accordance with the embodiment of the present invention;

FIG. 12 is a flow diagram illustrative of a routine for processing a test notification and returning indications of true or false;

FIG. 13 is a flow diagram illustrative of a routine for processing a test notification and returning indications with full details;

FIG. 14 is a flow diagram illustrative of a routine for utilizing user rules to process a test notification based on the test notification's content and the current user contexts;

FIGS. 15A and 15B are diagrams illustrative of pseudo code for a notification API;

FIG. 16 is a diagram illustrative of pseudo code for a context setting API;

FIG. 17 is a block diagram illustrating a notification processing system which receives inputs from context setters and notification senders;

FIG. 18 is a flow diagram illustrative of a general routine for calling a notification API;

FIG. 19 is a flow diagram illustrative of a general routine for calling a context setting API;

FIGS. 20A-20L are block diagrams illustrating various implementations of a programming interface that may be utilized in a notification system;

FIG. 21 is a diagram illustrating the setting of a user context and user rules;

FIG. 22 is a diagram illustrating the initiation of a notification event;

FIG. 23 is a diagram illustrating the drawing of a notification in response to a notification event;

FIG. 24 is a diagram illustrating an arbitrary process registering for communication events;

FIG. 25 is a diagram illustrating an arbitrary process receiving a communication event and in response thereto sending a customized announcement;

FIG. 26 is a flow diagram illustrative of a general routine for a process registering for communication events;

FIG. 27 is a flow diagram illustrative of a general routine for a process receiving a communication event and responding in accordance with an evaluation routine;

FIG. 28 is a flow diagram illustrative of a routine for a process to evaluate a communication event and send a customized announcement;

FIG. 29 is a flow diagram illustrative of a routine for a user to construct a query for returning a virtual folder containing all of the items meeting the query;

FIG. 30 is a flow diagram illustrative of a routine continuing from the routine of FIG. 29 wherein the user is able to select additional parameters for further refining the query set;

FIG. 31 is a flow diagram illustrative of a routine for a user to create a query including a sub-query;

FIG. 32 is a flow diagram illustrative of a routine for following a rule to look for new items conforming to a data set;

FIG. 33 is a flow diagram illustrative of a routine continuing from the routine of FIG. 32 wherein an action dictated by a rule may be modified when the action is affected by other rules;

FIG. 34 is a flow diagram illustrative of a routine for a user to create additional rules to further automate a work flow process;

FIG. 35 is a flow diagram illustrative of a routine for automating a work flow process through utilization of multiple rules;

FIG. 36 is a flow diagram illustrative of a routine for providing a set of base operations from which a user may select specified actions for rules; and

FIG. 37 is a flow diagram illustrative of a routine for a third party to add an action and thereby extend an operating system.

### DETAILED DESCRIPTION OF THE PREFERRED EMBODIMENT

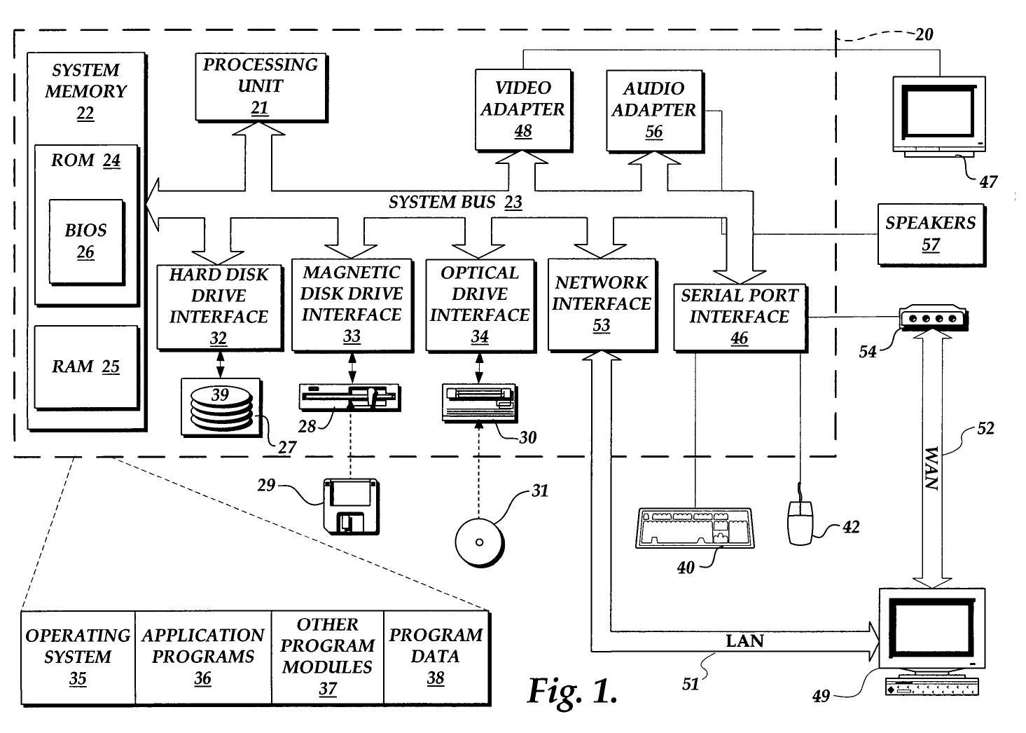

FIG. 1 and the following discussion are intended to provide a brief, general description of a suitable computing environment in which the embodiment of the present invention may be implemented. Although not required, the invention will be described in the general context of computer-executable instructions, such as program modules, being executed by a personal computer. Generally, program modules include routines, programs, characters, components, data structures, etc., that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the invention includes a general purpose computing device in the form of a conventional personal computer 20, including a processing unit 21, system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that helps to transfer information between elements within the personal computer 20, such as during start-up, is stored in ROM 24. The personal computer 20 further includes a hard disk drive 27 for reading from or writing to a hard disk 39, a magnetic disk drive 28 for reading from or writing to a removable magnetic disk 29, and an optical disk drive 30 for reading from or writing to a removable optical disk 31, such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer-readable instructions, data structures, program modules, and other data for the personal computer 20. Although the exemplary environment described herein employs a hard disk 39, a removable magnetic disk 29, and a removable optical disk 31, it should be appreciated by those skilled in the art that other types of computer-readable media which can store data that is accessible by a computer, such as magnetic cassettes, flash memory cards, digital video disks, Bernoulli cartridges, random access memories (RAMs), read-only memories (ROMs), and the like, may also be used in the exemplary operating environment.

A number of program modules may be stored on the hard disk 39, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may also be connected by other interfaces, such as a parallel port, game port or a universal serial bus (USB). A display in the form of a monitor 47 is also connected to the system bus 23 via an interface, such as a video card or adapter 48. One or more speakers 57 may also be connected to the system bus 23 via an interface, such as an audio adapter 56. In addition to the display and speakers, personal computers typically include other peripheral output devices (not shown), such as printers.

The personal computer 20 may operate in a networked environment using logical connections to one or more personal computers, such as a remote computer 49. The remote computer 49 may be another personal computer, a server, a router, a network PC, a peer device or other common network node, and typically includes many or all of the elements described above relative to the personal computer 20. The logical connections depicted in FIG. 1 include a local area network (LAN) 51 and a wide area network (WAN) 52. The local area network 51 and wide area network 52 may be wired, wireless, or a combination thereof. Such networking environments are commonplace in offices, enterprise-wide computer networks, intranets, and the Internet.

When used in a LAN networking environment, the personal computer 20 is connected to the local area network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20 or portions thereof may be stored in the remote memory storage device. It will be appreciated that the network connections shown are exemplary, and other means of establishing a communications link between the computers may be used.

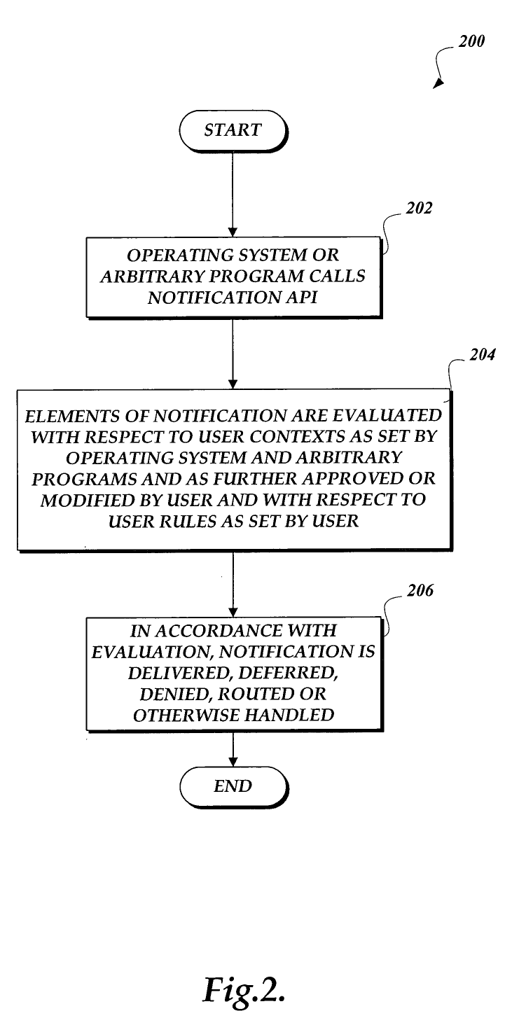

As will be described in more detail below with respect to FIGS. 2-10, in one embodiment a user context system may consist of three elements that are compared for a decision as to how to process a notification. The first element is the user's context (as may be provided by the operating system and arbitrary programs that have extended it). The second element is the user's rules and preferences. The third element is the notification itself (which contains elements such as data and properties that may match the user's rules).

As will be described in more detail below, the system operates by the operating system and other programs declaring a user's contexts, after which the system brokers the user's context and rules. Notifications are raised by other programs calling into the system. The user's context, rules, and elements of the notification are compared and then a determination is made as to what should be done with the notification. Examples of various options for what may be done with the notification include denying (if the notification is not allowed to draw or make noise, and the notification is to never be seen by the user), deferring (the notification is held until the user's context changes or the user's rules dictate that it is subsequently appropriate to deliver), delivering (the notification is allowed to be delivered in accordance with the user's context and rules), and routing (the user's rules indicate that the notification should be handed off to another system, regardless of whether the notification is also allowed to be delivered in the present system).

Various routines for delivering a notification are described in more detail below. In general, the user may be in a state deemed “unavailable” in which case the notification is either not delivered or held until the user becomes “available.” For instance, if the user is running a full screen application, that user may be deemed unavailable. Or, the user may be “available” but in such a state that the notification needs to be modified to be appropriate for the user. For instance, if the user is listening to music or in a meeting, the user may have indicated that the notifications should be delivered to the user's screen but that the sound they make should be either quieter or not made at all.

As noted above, the user context determines in part whether notifications are shown on the user's screen. When a notification is shown, it may be shown based on certain gradients within the user context. In other words, there are different levels of invasiveness of the form of the drawn notification that may be specified. For example, a normal notification is free to pop out into the client area and briefly obscure a window. If the user is in a slightly restrictive context, the notification may be free to show, but only in a less invasive manner, such as it might not be allowed to draw on top of another window. As another example, in one embodiment where the user is running a maximized application, the default setting may be that this means that context is slightly restricted, and that the user has clearly made a statement that they want this application to get the entire client area. In this setting, a notification may still be allowed to draw, but may be made to only appear within the sidebar. In other words, this type of reduced invasiveness in the notification drawing form lessens the impact of the notification, and overall lessens the cognitive load.

FIG. 2 is a flow diagram illustrative of a routine 200 for processing a notification. At a block 202, the operating system or an arbitrary program calls a notification application programming interface (API). At a block 204, the elements of the notification are evaluated with respect to user contexts as set by the operating system and arbitrary programs, and as further approved or modified by the user, and with respect to user rules as set by the user. At a block 206, a notification is delivered, deferred, denied, routed, or otherwise handled in accordance with the user contexts and user rules.

The user contexts and user rules will be described in more detail below. In one embodiment, a user context consists of a condition that may be either true or false, and an instruction for determining how a notification should be handled when the condition is true. In general, the condition of a user context can be thought of as a state that the system assumes makes the user in some way unavailable for notification delivery or that causes the way that the notification is delivered to be different from how it was sent by the program that initiated it. In other words, in one embodiment a user context can be thought of as a statement that “while condition X is true, then this is what should be done with incoming notifications.” An example would be “when my music player is playing music for me, incoming notifications should show on the screen but not play sound.” Another example would be “while any application is running in full screen mode, incoming notifications should be deferred until later.”

With respect to such user contexts, in one embodiment a user may also define special rules for handling incoming notifications, and thus may provide for special exceptions to the instructions of the user contexts. As an example, a user rule might state “when I receive a new e-mail from ‘John Doe,’ and with ‘urgent’ in the text, and marked ‘high priority,’ deliver the e-mail regardless of other user contexts.” In other words, in this example this user rule provides an exception to a user context which would otherwise indicate that it is inappropriate to deliver a notification for an incoming e-mail at this time. With regard to the elements of the notification that the user rules are evaluated with respect to, these may include things like text, sound, graphics, and other properties such as priority, the person who sent the notification (for channels such as e-mail or instant messaging), when the notification expires, and some elements of code such that the user can interact with the notification and launch arbitrary code (e.g., clicking on buttons or text within the notification can cause new programs to launch or actions to be taken [such as deleting e-mail] on programs that are currently running).

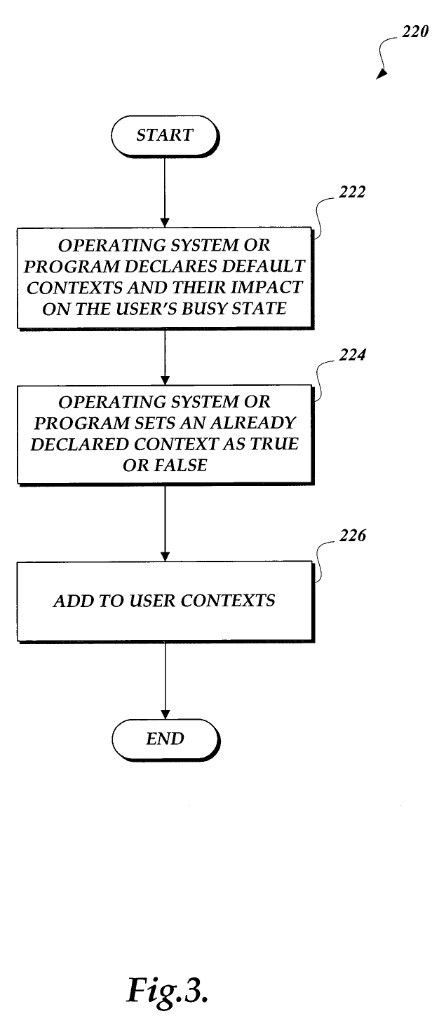

FIG. 3 is a flow diagram illustrative of a routine 220 for an operating system or arbitrary program declaring user contexts. At a block 222, the operating system or program declares the default contexts and their impact on the user's busy state. In other words, programs register with the system and provide user contexts including the impact they have on the notifications (e.g., if drawing on the screen is appropriate and whether or not sound is appropriate or at what relative volume sound should be played). As an example, a music player program may declare a default context that states “when the music player is playing music for the user, incoming notifications should show on the screen but not play sound.” As another example, the operating system might declare a context which states “while any application is running in full screen mode, incoming notifications should be deferred until a later time.”

Returning to FIG. 3, at a block 224, the operating system or program sets the declared context as true or false. For example, with regard to the music player declaring the context of “when the music player is playing music, incoming notifications should show on the screen but not play sound,” the music player program also sets this declared context as currently being true or false. In other words, the music player program indicates whether it is true or false that the music player is currently playing music. As will be described in more detail below, in one embodiment, the determination of whether a context is true or false may also be evaluated at the time the notification API is called, or at the time the user rules and exceptions are re-evaluated. As an additional feature, the system may also check to see if the calling program has not terminated unexpectedly or forgotten to reset the context, and the system will modify its settings appropriately due to this data. One specific implementation of this feature would be the system tracking the process handle of the calling program (it will be appreciated that other means may also be used for checking on the calling program), such that if the process terminates without first resetting the context value to its default ‘false’ value, the system will reset the context value as soon as it detects that the initial process does not exist any more (in one embodiment, the process handle state is set to signal when the process terminates, and that state change is picked up by the system which watches the process handle). This ensures that if processes terminate unexpectedly or forget to reset the context, then the delivery of further notifications will not be unduly affected. For example, if in the above example the music player program has been closed and the process is no longer present, then the context may automatically be reset to false. As another example, if a program originally declares a user as being busy, but then the program crashes, such that the process is no longer present, the context may automatically be set to false rather than leaving the user stuck in a state where notifications would not be received. In any event, whether or not a context is actively set or is evaluated as a function, in one embodiment the contexts can generally be resolved to be either true or false.

Returning to FIG. 3, at a block 226, the context information is added to the user contexts that are stored in the system. This process is repeated by additional programs declaring contexts. In addition, as noted above, the state of whether already declared contexts are true or false will change over time as the user opens and closes different programs and undertakes different tasks.

As noted above, in one embodiment registering a context is a declarative process. As will be described in more detail below, in accordance with one aspect of the invention, by registering the user contexts, the user can be presented with a list of the contexts so that the user can choose to not accept certain contexts or to change what they mean if the user disagrees with the context parameters. As noted above, in one embodiment, a context may consist of a condition that may be true or false, and an instruction for what to do with notifications when the condition is true. In this regard, a user context may comprise specific programming elements, such as: a human readable string (for the end user to know what is meant); a unique identifier (such as a globally unique identifier, aka GUID) so that the program can tell the operating system when this context is true or not; and the instruction which may comprise a statement of what this context means in terms of notifications drawing on screen (as may include invasiveness level, sound, and volume). A context may also be dynamic, as will be described in more detail below.

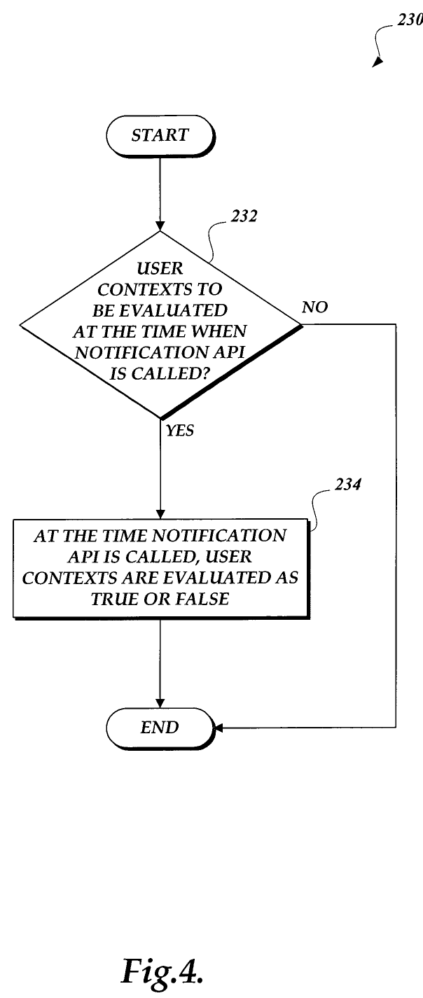

FIG. 4 is a flow diagram illustrative of a routine 230 for a context to be evaluated as true or false at the time the notification API is called. At a decision block 232, a determination is made whether the user contexts are to be evaluated at the time when the notification API is called. If the user contexts are to be evaluated, then the routine proceeds to block 234. If the user contexts are not to be evaluated at the time when the notification API is called, then the routine ends. At block 234, the user contexts are evaluated as true or false.

As illustrated by FIGS. 3 and 4 and as noted above, a context may be proactively set or it may be a function that is evaluated at a relevant time. As an example, a program may actively note that a user is listening to music. As another example, when a notification is evaluated, the program may have registered its callback such that the program is queried by the system at the time the notification is evaluated whether the context is true. One example of a case where this second process can be particularly important is when a user context is combined with a user rule to form a dynamic context. (User rules will be described in more detail below.) A specific example of a user context combined with a user rule would be when a user has set a rule that states “people who I'm meeting with right now can always send me notifications irrespective of my busy state.” In this case, the user context of “when the user is in a meeting,” must further be evaluated in terms of who the user is in the meeting with. In this example, the program that handles the meetings may register this as a dynamic context, and when a notification is evaluated, the person who sent the notification is evaluated against this context (which otherwise could not be declared as true or false proactively, since the people attending the meeting may change over time). In other words, this particular example requires evaluation of a user's context in light of a user rule that depends on other people's contexts.

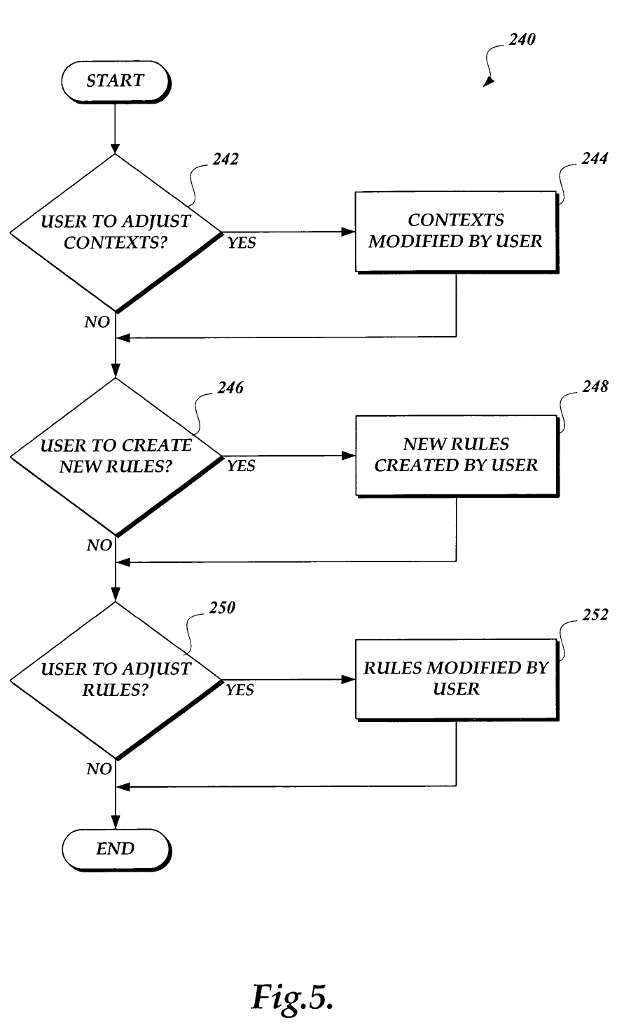

FIG. 5 is a flow diagram illustrative of a routine 240 by which a user may adjust contexts and create new rules. At a block 242, a determination is made whether the user wishes to adjust the contexts. If the user does not wish to adjust the contexts, then the routine proceeds to a decision block 246, as will be described in more detail below. If the user does wish to adjust the context, then the routine proceeds to a block 244, where the user makes modifications to the contexts.

In one embodiment, the contexts that have been provided may be exposed to a user in a manner which allows the user to either turn the contexts off (e.g., the user doesn't agree with the program's assessment of the context), or to change the context in terms of the impact on delivery of a notification. As more specific examples, user contexts can include things like “while any application is running in full screen mode”; “when I'm playing music or video”; “when my meeting manager shows me in a meeting”; or “when my out of office assistant is turned on.” For each of these, the user could be allowed to make selections that specify an instruction that when the given condition is true, the incoming notifications should follow selected procedures. The instructions can specify things like whether or how the notification will draw on the screen, and the sound or volume that the notification will make. For the volume, the user can specify a percentage of desired volume under the given condition. For the options for drawing the notification on the screen, the user can be provided with options such as not drawing the notification at all, or drawing the notification only on a specified external display, or drawing the notification on the present screen. For the drawing of a notification, different levels of invasiveness can be specified. For example, if a user is running a maximized application, such that the context is slightly restricted, the invasiveness setting might be such that notifications can still draw, but might appear only within a sidebar.

Returning to FIG. 5, at decision block 246, a determination is made whether the user wishes to create new user rules. If the user does not wish to create new user rules, then the routine proceeds to a decision block 250, as will be described in more detail below. If the user does wish to create new user rules, then the routine proceeds to a block 248, where new rules are created. In general, user rules dictate how notifications that contain specified elements should be handled. For example, a rule may dictate that notifications from a specified person should always be delivered immediately, and this rule can be applied to all notifications, irrespective of which program initiated the notification as long as it is from the specified person. As more specific examples, other user rules may be directed to things like “MSN auto's traffic alerts for Bremerton, Wash.” and “important e-mails from John Doe.” As an example of a user rule for an important e-mail from John Doe, the rule could dictate that any e-mails that arrive from John Doe, and with “urgent” in the text, and marked “high priority,” should follow specified handling conditions. The handling conditions could specify that the notification should be delivered immediately and that the user should be required to acknowledge it. In general, requiring a user to acknowledge a notification means that there is a slightly raised elevation in the form of the notification's invasiveness, in that the notification will stay on-screen until the user specifically dismisses it. In one embodiment, the requiring of a user's acknowledgement is only settable via a user rule. As another example, the rules could also specify a custom sound to be played for the notification, at a specified volume, so as to provide an alert to the user that a special notification has arrived. Different settings may also be selected for how the notification should be handled during “normal” and “busy” conditions for the user, as may be determined by the user's context. The handling instructions may also include things like routing options for the notification, such as “deliver notifications from John Doe to my pager.” In one embodiment, when the context is evaluated, the most restrictive currently true context is the one that is applied. When user rules are evaluated, it means that a particular notification has matched the rule that the user has created, in which case the most invasive setting is applied from the user rules which have matched the notification. In other words, in the user rules, a user has specified something to be of importance, and this procedure is intended to follow the user's preferences. If there is a conflict between two rules, the most invasive is applied.

In one embodiment, the user rules may also be directed to controlling the delivery of notifications from specific notification services. For example, an operating system that provides notifications in accordance with a notification service may provide the user with a way to modify how the notifications are delivered. For example, the specified notification service may provide “traffic alerts for Seattle,” and the user may edit the delivery to be such that when such notifications are received the system should “show the notification and play sound.”

Returning to FIG. 5, at decision block 250, a determination is made whether the user wishes to adjust any of the already existing user rules. If the user does not wish to adjust any of the rules, then the routine ends. If the user does wish to adjust the user rules, then the routine proceeds to a block 252, where the user makes modifications to the rules.

As described above with respect to FIGS. 3-5, the user contexts and user rules are set by the operating system, programs, and the user. The system appropriately brokers and serializes the delivery of the notifications in accordance with the user's preferences. The user contexts and user rules may be exposed to the user such that the user can modify or adjust the various contexts and rules, or create new rules. This provides the user with a centralized way to manage preferences for how notifications are handled. It will be appreciated that this allows a user to effectively manage the many competing elements in a computing system that may want to send notifications to the user.

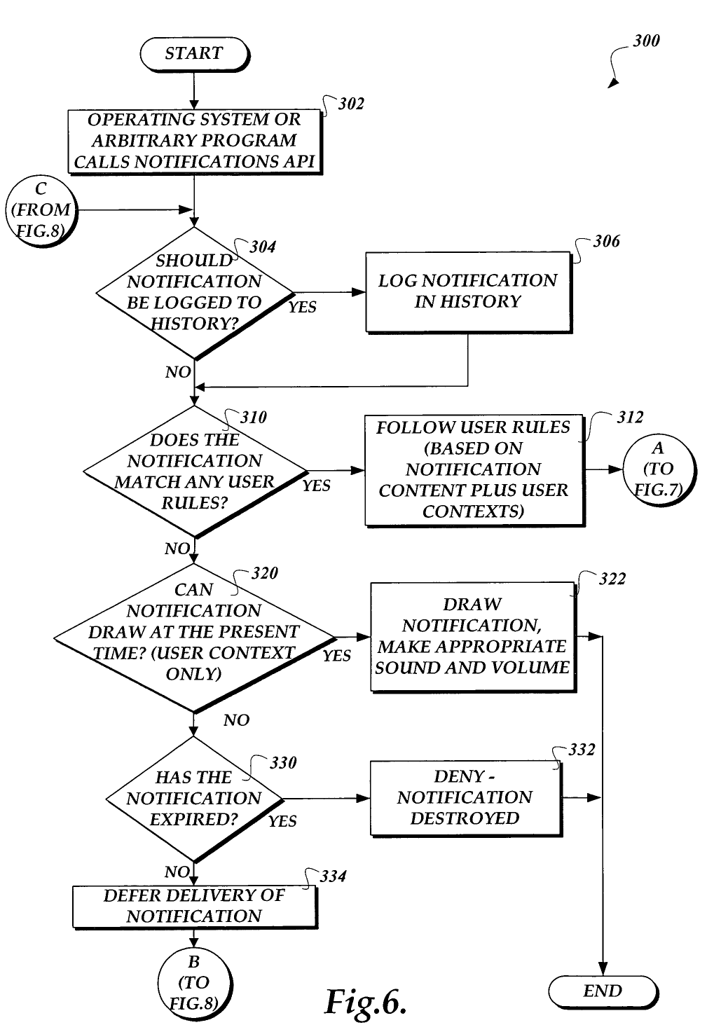

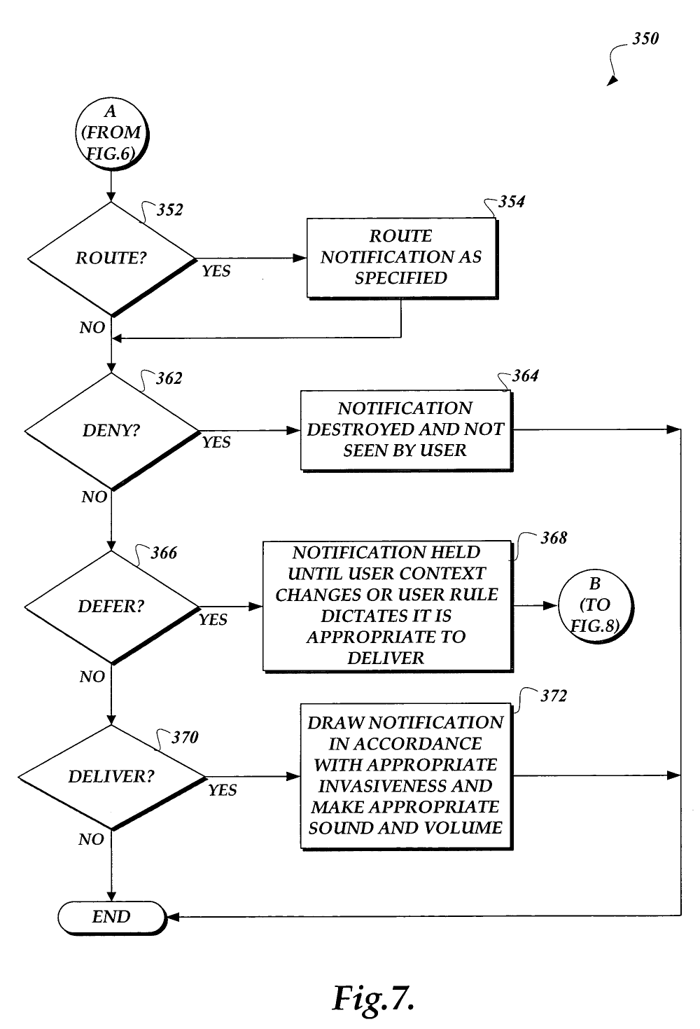

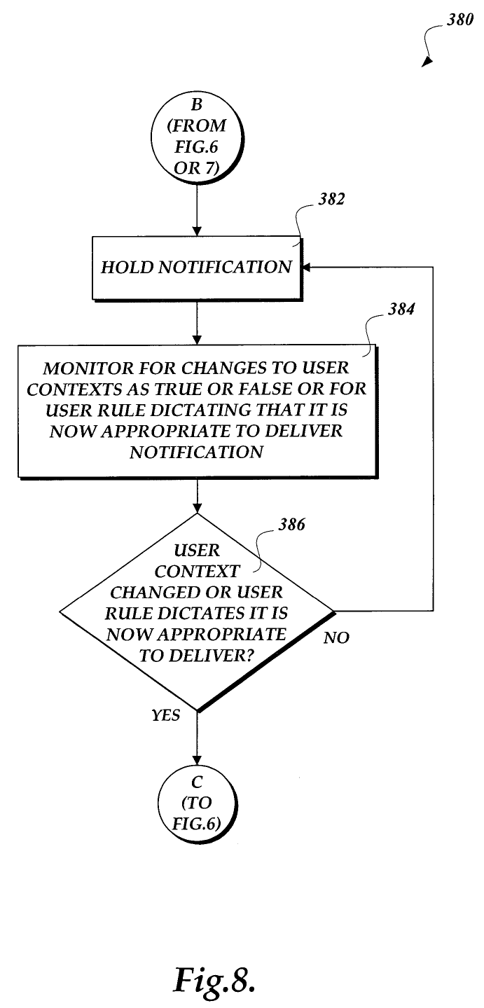

FIG. 6 is a flow diagram illustrative of a routine 300 for processing a notification in accordance with user contexts and user rules. At a block 302, the operating system or an arbitrary program calls the notifications API. At a decision block 304, a determination is made whether the notification should be logged to the notification history. If the notification is to be logged, then the routine proceeds to a block 306, where the notification is logged to the history. If the notification is not to be logged, then the routine proceeds to a decision block 310.

At decision block 310, a determination is made whether the notification matches any user rules. If the notification matches any user rules, then the routine proceeds to a block 312, where the user rules are followed (based on the notification content plus the user contexts), and the routine continues to a point A that is continued in FIG. 7. If at decision block 310 the notification does not match any user rules, then the routine continues to a decision block 320.

In one embodiment, user rules always outweigh the current user contexts. As noted above, user rules can be based on any element of the notification. For example, a rule that is based on an evaluation of the person who initiated the notification, can be applied to all notifications, irrespective of which program initiated the notification as long as it is from the person on which the rule is based (e.g., “John Doe” can always reach me). In addition, notifications may draw on the screen even during contexts that would otherwise cause it not to draw (e.g., “people who are in a meeting with me can always send me notifications,” even though the user context generally states that the user is not to receive notifications during a meeting).

Returning to FIG. 6, at decision block 320, a determination is made whether the notification can draw at the present time (based on the user context only). If the notification can draw at the present time, then the routine continues to a block 322, where the notification is drawn, and appropriate sound and volume are provided. If it is not appropriate to draw the notification at the present time, then the routine proceeds to a decision block 330.

At the decision block 330, a determination is made whether the notification has expired. If the notification has expired, then the routine proceeds to a block 332, where the notification is destroyed. If the notification has not expired, then the routine proceeds to a block 334, where the notification is deferred, and the routine continues to a point B that is continued in FIG. 7.

FIG. 7 is a flow diagram illustrative of a routine 350 for processing a notification in accordance with specified user rules. The routine is continued from a point A from FIG. 6, as described above. As illustrated in FIG. 7, at a decision block 352, a determination is made whether the notification should be routed. If the notification is not to be routed, then the routine continues to a decision block 362, as will be described in more detail below. If the notification is to be routed, then the routine proceeds to a block 354, where the notification is routed as specified. When a notification is routed, it indicates that the notification contains elements that match the user's rules that require the notification to be handed off to another system. This may happen if the user is busy, or it may happen on every notification that matches the criteria specified in the user's rules, whether or not the user is unavailable. As an example, a notification with the word “urgent” in it might always be forwarded to the user's pager, whereas other notifications might only be routed based on a combination of the user's rules and context.

Some examples of routing instructions include: “Forward this notification to an e-mail address”; “forward this notification to another PC”; “forward this notification to a pager”; “forward this notification to a cell phone”; or “forward this notification to an e-mail server.” As will be described in more detail below, if the notification is routed, it may also be delivered and draw on the screen. In addition, the device to which the notification is forwarded may have this same context system implemented, and on that device there may be additional or different knowledge of the user's context, and the context system on that device may choose to do different actions with the notification.

Returning to FIG. 7, at decision block 362, a determination is made whether to deny the notification. If the notification is not to be denied, then the routine continues to a decision block 366, as will be described in more detail below. If the notification is to be denied, then the routine proceeds to a block 364 where the notification is destroyed and not seen by the user. In other words, a notification that is denied is not allowed to draw or make noise. For example, this may occur based on a user rule that states that a certain notification should be denied, or as described above with reference to block 332 of FIG. 6, when a notification has expired.

Returning to FIG. 7, at decision block 366, a determination is made whether the notification should be deferred. If the notification is not to be deferred, then the routine proceeds to a decision block 370, as will be described in more detail below. If the notification is to be deferred, then the routine proceeds to a block 368, where the notification is held until a user context changes, and the routine continues to a point B that is continued in FIG. 8. In general, deferring a notification indicates that the notification will be allowed to be delivered, but that the user's current context or rules are such that it is deemed inappropriate to deliver the notification at this time. As will be described in more detail below with reference to FIG. 8, once the user's context changes or alternatively when the user's rules indicate that it is subsequently appropriate, the notification will be delivered to the user's screen and allowed to draw and/or make its sound, as dictated by the user rules and user context.

Returning to FIG. 7, at decision block 370, a determination is made whether the notification should be delivered. If the notification is not to be delivered, then the routine ends. If the notification is to be delivered, then the routine proceeds to a block 372, where the notification is drawn in accordance with the appropriate level of invasiveness, and the appropriate sound and volume are provided. In other words, the notification is allowed to be delivered, though it is delivered in accordance with the user's context and rules (e.g., a notification may be allowed to be drawn but required to be silent).

FIG. 8 is a flow diagram illustrative of a routine 380 for deferring the delivery of a notification. The routine is continued from a point B from either FIG. 6 or 7, as described above. As illustrated in FIG. 8, at a block 382, the notification is held. At a block 384, the system monitors for changes to the declared contexts as being true or false, or for a user rule dictating that it is now appropriate to deliver the notification. At a decision block 386, a determination is made whether a user context has changed, or a user rule dictates that it is now appropriate to deliver the notification. If a user context has not changed and if no user rule otherwise dictates, then the routine returns to block 382, where the notification continues to be held. If the user context has changed or if a user rule dictates that it may now be appropriate to deliver the notification, then the routine proceeds to a point C which is continued in FIG. 6. Point C in FIG. 6 returns to the decision block 304, where the process for evaluating the notification starts over.

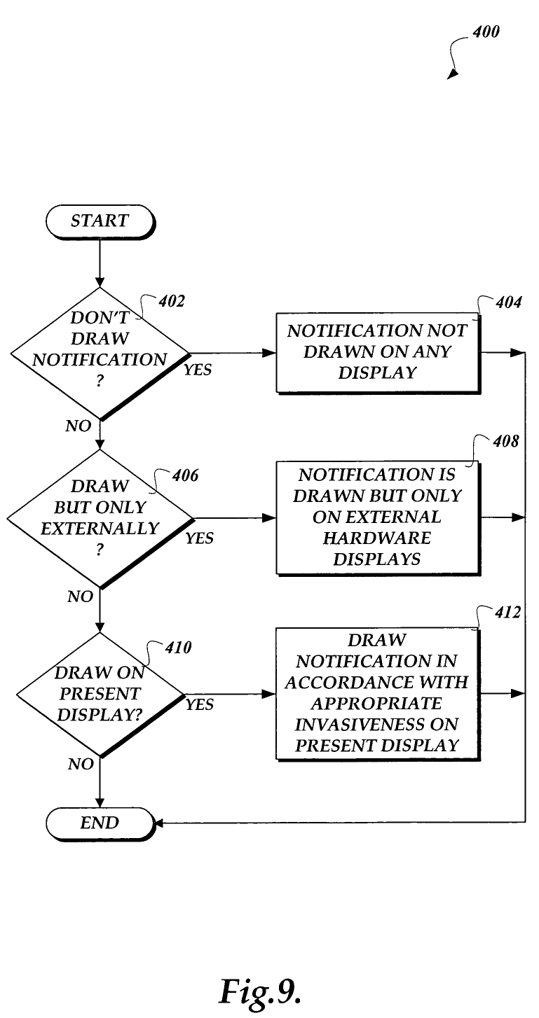

FIG. 9 is a flow diagram illustrative of a routine 400 for determining the drawing of a notification in accordance with various restrictions. It will be appreciated that this routine may be implemented as part of the processing of notifications, such as at block 322 of FIG. 6 or block 372 of FIG. 7. In general, when a notification enters the system, an evaluation is made of all of the contexts that are currently true, and the most restrictive settings for the notification are applied in accordance with the user's current state. As illustrated in FIG. 9, at a decision block 402, a determination is made whether the notification should not be drawn at all. If the notification is not to be drawn at all, then the routine proceeds to a block 404, where the notification is set to not be drawn on any display. If the notification is to be drawn, then the routine proceeds to a decision block 406.

At decision block 406, a determination is made whether the notification should be drawn but only externally. If the notification is only to be drawn externally, then the routine proceeds to a block 408, where the notification is drawn but only on external hardware displays. If the notification is not to be drawn on external hardware displays, then the routine proceeds to a decision block 410.

At decision block 410, a determination is made whether the notification should be drawn on the present display. If the notification is to be drawn on the present display, then the routine proceeds to a block 412, where the notification is drawn in accordance with the appropriate level of invasiveness on the present display. If the notification is not to be drawn on the present display, then the routine ends.

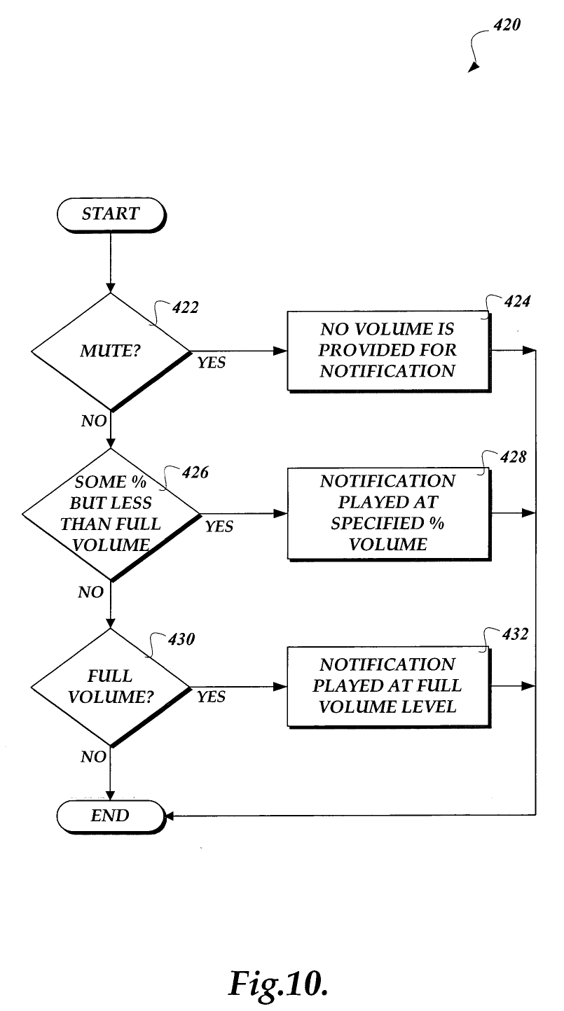

FIG. 10 is a flow diagram illustrative of a routine 420 for determining the volume that will be played for the sound of a notification, in accordance with various restrictions. As was described above with respect to FIG. 9, it will be appreciated that this routine may be implemented as part of the processing of notifications, such as at block 322 of FIG. 6 or block 372 of FIG. 7. When the notification enters the system, an evaluation is made of all the contexts that are currently true, and the most restrictive settings are applied to the notification in accordance with the user's current state. As illustrated in FIG. 10, at decision block 422, a determination is made whether the notification should be muted. If the notification is to be muted, then the routine proceeds to a block 424, where no volume is provided for the notification. If the notification is not to be muted, then the routine proceeds to a decision block 426.

At decision block 426, a determination is made whether the notification should be provided with some percentage but less than full volume. If some percentage volume is to be provided, then the routine proceeds to a block 428, where the notification is played at the specified percentage volume. If a specified percentage volume is not to be provided, then the routine proceeds to a decision block 430.

At decision block 430, a determination is made whether full volume should be provided for the notification. If full volume is to be provided, then the routine proceeds to a block 432, where the notification is played at the full volume level. If full volume is not to be provided, the routine ends. In one embodiment, in addition to providing for different volume levels for the notification, different sounds may also be selected for the notification in accordance with the user context and rules.

It will be appreciated that the user context system as described above with respect to FIGS. 1-10 controls the delivery of notifications from various sources such that the notifications stop conflicting with one another because the system appropriately brokers and serializes their on-screen rendering. In addition, the notifications that are processed by the user context system can be considered to be more valuable because they are delivered when the user is more receptive to them, and in addition the use of common rules helps the user to eliminate undesired notifications.

As described above, the system brokers and serializes the delivery of notifications from multiple sources. In addition, a shared notion of user context is provided for determining the appropriate handling for each of the notifications. In accordance with these aspects, the notifications that are delivered by the system may be considered to be more valuable in that they are delivered when the user is more receptive to them. These aspects also provide for common rules which help the user to eliminate undesirable notifications.

User contexts are declared by the operating system and arbitrary programs. In one embodiment, a user context comprises a condition that may be true or false, and an instruction that is to be followed if the condition is true. For example, a condition might be “when a user is listening to music,” for which the instruction might be “deliver notifications on the screen but with no sound.” In general, the condition for the user context can be thought of as a state that the system assumes makes the user in some way unavailable for notification delivery or that causes the way that the notification should be delivered to be different from how it was sent by the program that initiated it. The user may be in a state deemed “unavailable” in which case the notification is either not delivered or held until the user becomes “available.” For instance, if the user is running a full screen application, where the application is using or being displayed on the full area of a display screen, that user may be deemed unavailable. Or, the user may be “available” but in such a state that the notification needs to be modified to be appropriate for the user.

In addition to the operating system declaring contexts, programs register with the system and declare the context they provide and the impact it has on notifications (as per if drawing on the screen is appropriate and the level of invasiveness that is appropriate for drawing on the screen and whether or not sound is appropriate or at what relative volume sound should be played at) and then tells the system whether the context is true or false. In one embodiment, the context may also be evaluated as true or false at the time that a notification is to be delivered. In one embodiment, the system may also track the process of the calling program, and if the process is no longer present, the context may be reset to false. By tracking the process, certain undesirable situations can be avoided, such as an application declaring a user as being busy, and then crashing, and then leaving the user stuck in a state in which they have been declared as not being available for receiving notifications.

There may be different levels of invasiveness specified for the drawing of notifications. In other words, based on the user context, there may be gradients for the drawing of notifications, such that there may be different levels of invasiveness in the form of the drawn notification. For example, a normal notification may be free to be drawn in the client area and briefly obscure a window. If the user is in a slightly restrictive context, the notification may be free to show, but only in a less invasive manner, such as it might not be allowed to draw on top of another window. As another example, if a user is running a maximized application, the setting may be that the user context is slightly restricted, in that the user has clearly made a statement that they want their current application to get the entire client area. In this circumstance, notifications may still be allowed to draw, but they may be made to only appear within the sidebar. This type of reduced invasiveness in the notification drawing form lessens the impact of the notifications, and lessens the cognitive load.

The contexts that have been provided are exposed to the user and can either be turned off (e.g., the user doesn't agree with the program's assessment of the context) or changed in terms of the impact on delivery. The user may define rules that dictate how notifications that contain specified elements should be delivered. For example, a user rule might dictate that any notifications received from “John Doe” and with “urgent” in the subject line, should be delivered immediately. In one embodiment, such user rules are given precedence over the user contexts. The user rules are made available to the user for modification in accordance with the user's preferences.

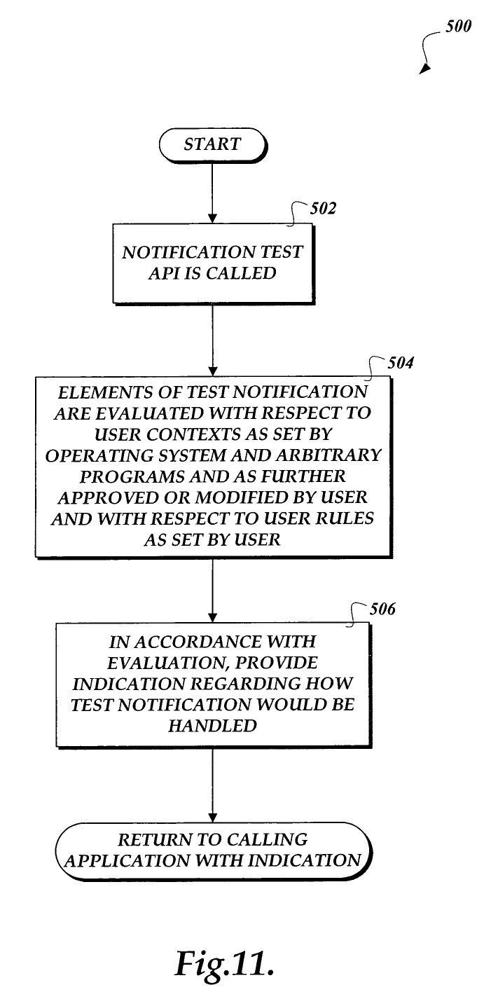

FIGS. 11-14 are directed to the evaluation of test notifications. As will be described in more detail below, the test notifications can be utilized by any program to obtain information about the current state of a user context. One advantage of this aspect is that the user context information can be obtained by any program, regardless of whether the program intends to use the service already built in the system, or whether the program is to extend it by rolling its own interpretation of what the notification should look like or the way it should be delivered. In other words, future programs with more advanced notifications that are not designed to be limited by the rendering provided to them by the system will still be able to utilize test notifications to obtain information about the user's current context. Such more advanced notifications are likely to occur as the richness of notifications continues to grow and change, and new user interfaces for notifications continue to develop.

As an example, a future user interface may provide rich full screen animations that draw only when the user is not “busy.” For instance, placing a CD into the CD-ROM drive might present an animation of a CD on the screen, while the CD-ROM spins up (due to technical constraints, there is a period of time from when the CD is first inserted until the CD may be read even though it is known to be in the drive—and during this time period an animation could be used to show the user that the system is aware of the CD, but just can't read from it yet). By using the test notifications of the embodiment of the present invention, the animation program will be able to know about the user's current context and can choose to not show on-screen if the user is not receptive to notifications right now.

As another example, a future instant messaging program may develop a new user interface for notifications that could not be done with the current notification engine. The development of such new user interfaces is desirable. Test notifications could continue to be utilized by the instant messaging program to determine whether it should show/not show its more advanced notifications in accordance with user's current context.

The test notifications can also be utilized to prevent unwanted notifications from being generated. This aspect can be applied to any programs that attempt to send notifications to the system. In other words, by enabling a program to have a richer view of the user's context, unwanted notifications can be prevented from being generated by the programs, thus proactively ending the generation of these types of notifications until the user is in a receptive state. The following examples provide further illustrations of this aspect.

As one example, an instant messaging program may provide a list of contacts. The test notifications are able to tap into the context system on a per-contact basis (e.g., “if Tom were to send you an instant message right now, would it show?” and “if Chris were to send you an instant message right now, would that show?”). On the basis of this information, the instant messaging program can begin broadcasting definite busy or free states to individual contacts. This technique could be used to preemptively stop unwanted notifications from being generated, rather than simply suppressing them once they are received.

As another example, if a user is busy, a mail program could make use of this to provide an automated reply to the sender (either to all senders based on rules that the user has provided, such as “my direct reports” or “my manager”). The automated reply could indicate “I am busy right now, but will respond when I have a chance.” In general, the communications of the system as a whole can be improved by exposing the user's context to arbitrary programs.

As described above, an application is able to construct a test notification and receive back specifically whether or not an actual notification would draw on the screen at the present time. As noted above, this allows programs to continue to use the user context system even after new user interfaces for notifications are developed. In addition, by enabling these new richer scenarios for other programs, all programs that utilize the system can be considered to be richer and more intelligent based on having increased access to information about the user's behavior and preferences.

FIG. 11 is a flow diagram illustrative of a general routine 500 for processing a test notification. The routine is similar to the routine of FIG. 2 for processing an actual notification. As illustrated in FIG. 11, at a block 502, the notification test API is called. At a block 504, the elements of the test notification are evaluated with respect to the user contexts as set by the operating system and arbitrary programs and as further approved or modified by the user, and with respect to any user rules as set by the user. At a block 506, in accordance with the evaluation of the test notification, an indication is provided regarding how the test notification would be handled. The indication is then returned to the calling application.

In one embodiment, the notification test API is called when the operating system or an arbitrary program decides that it needs to understand how busy the user currently is. One example of when this might occur would be when there is a decision point for whether or not to draw a notification on the screen. Another example would be to use this data to inform an action that the program wants to take on the user's behalf.

When the notification test API is called, the calling program constructs a notification that is as close to what it would send if it were using the notification methods of the user context system for sending an actual notification, and then uses an optional method to test (which returns the result and also guarantees that this particular notification will not be shown on-screen). One example of this process would be an instant messaging program wanting to broadcast an appropriate free or busy state to each contact based on the current user's context. The instant messaging program would create a test notification for each contact, and based on the return value broadcast a different free or busy state on a per-contact basis. Another example would be a program wanting to show an animation based on a user context (e.g., the CD-ROM animation example described above). The code that wants to show the animation would construct a notification (in this case, the contents simply being a simple notification with an image or animation sequence as this is just a test as to whether or not the given notification would draw), and then uses the test method, and then the return results could be used as a guide for whether or not the animation should currently be played. In one embodiment, the calling code will generally at least raise the most-generic notification possible as a test notification. If there is richer data available (such as the contact from the contact list), then including this information makes the test notification more accurate as the user may have custom user rules on a per person basis that may affect the returned results.

One implementation that may be utilized for the notification test API is a polling implementation. In the instant messaging program example described above, for the polling implementation the instant messaging program would periodically re-poll the notification test API to determine how to change the broadcast data. Another implementation that can be utilized for the notification test API is a subscription callback implementation. In this implementation, the instant messaging program would “subscribe” to context changes. Then, rather than periodically re-polling, as the user context changes in ways that change what the instant messaging program would be able to broadcast, the context engine can call back to the instant messaging program with appropriate updates. In some scenarios, this is advantageous, in that there is no lag between the context changes and what is broadcast (whereas with the polling implementation, there will tend to be moments when the broadcast state does not match the current user context). For other scenarios, the polling implementation may be more appropriate (as these are responses to one-time events, e.g., a CD being inserted into a CD-ROM).

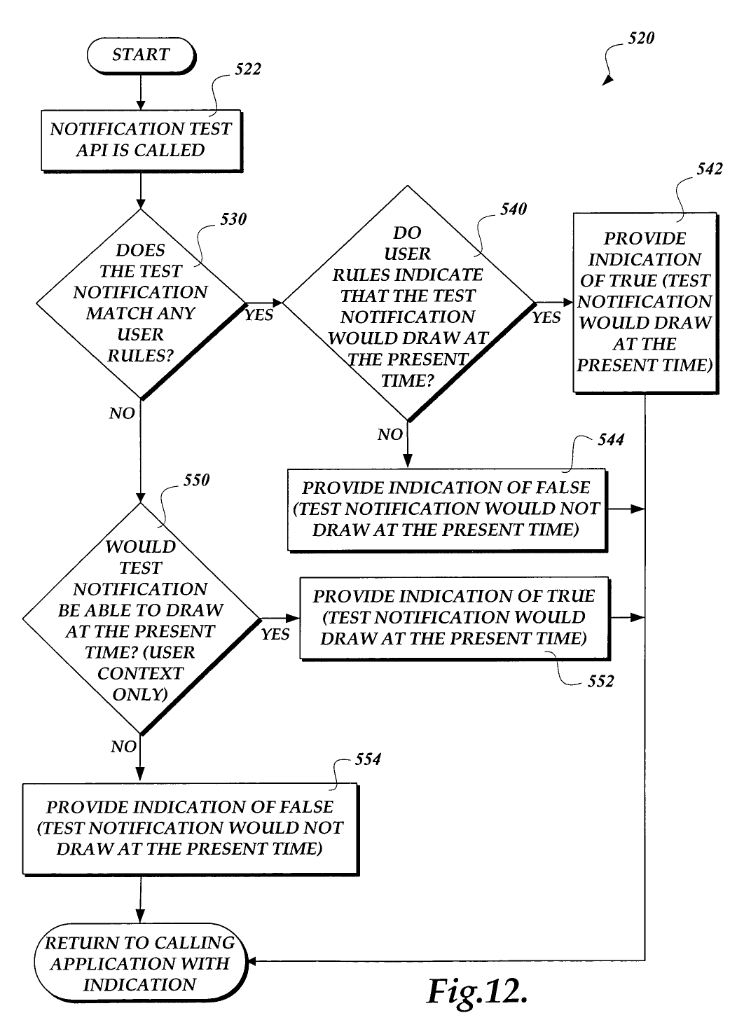

FIG. 12 is a flow diagram illustrative of a routine 520 for processing a test notification and returning an indication of true or false for whether or not the test notification would draw at the present time. At a block 522, the notification test API is called. At a decision block 530, a determination is made whether the test notification matches any user rules. If the test notification does not match any user rules, then the routine proceeds to a decision block 550, as will be described in more detail below. If the test notification does match any user rules, then the routine proceeds to a decision block 540.

At decision block 540, a determination is made whether the user rules indicate that the test notification would draw at the present time. If the test notification would draw at the present time, then the routine proceeds to a block 542, where an indication of true is provided. If the test notification would not draw at the present time, then the routine proceeds to a block 544, where an indication of false is provided.

At decision block 550, a determination is made whether the test notification would be able to draw at the present time (in relation to the user context only). If the test notification would be able to draw at the present time, then the routine proceeds to a block 552, where an indication of true is provided. If the notification would not be able to draw at the present time, then the routine proceeds to a block 554, where an indication of false is provided. From blocks 542, 544, 552 and 554, the routine returns to the calling application with the designated indication.

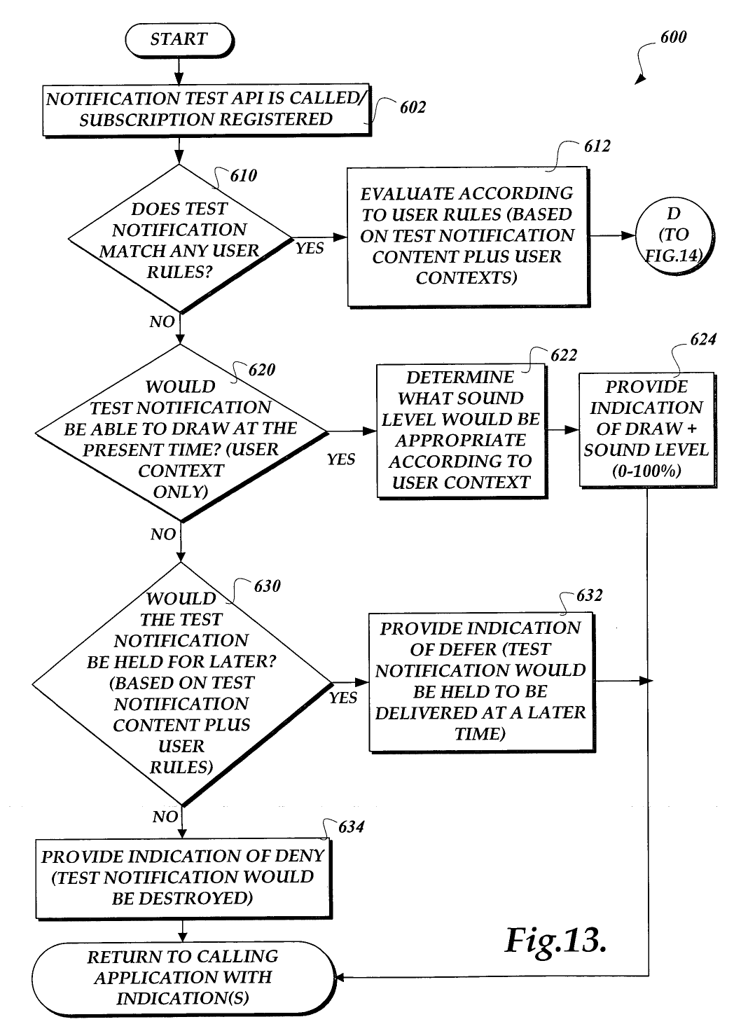

FIG. 13 is a flow diagram illustrative of a routine 600 for processing a notification and returning detailed indications. As noted above, the routine 520 of FIG. 12 only provides a return value with an indication of true or false, with regard to whether or not the notification would draw at the present time. As will be described in more detail below, the routine 600 of FIG. 13 returns richer return values (e.g., the notification would not draw right now, but it would draw as soon as the user's context changes, or it would route to another device, etc.). This provides for richer logic in the calling code. This allows for advanced functionality in programs that are able to utilize such richer return values.

It should also be noted while the return values are being described as part of a function call, in another embodiment this data may be passed as part of a callback. In other words, the calling application can set up a “subscription” to a notification such that when a user's context subsequently changes (as would affect the delivery of notifications from the calling application) then the calling application is notified. This requires no polling, and in some cases is thus better for the robustness and performance of the system.

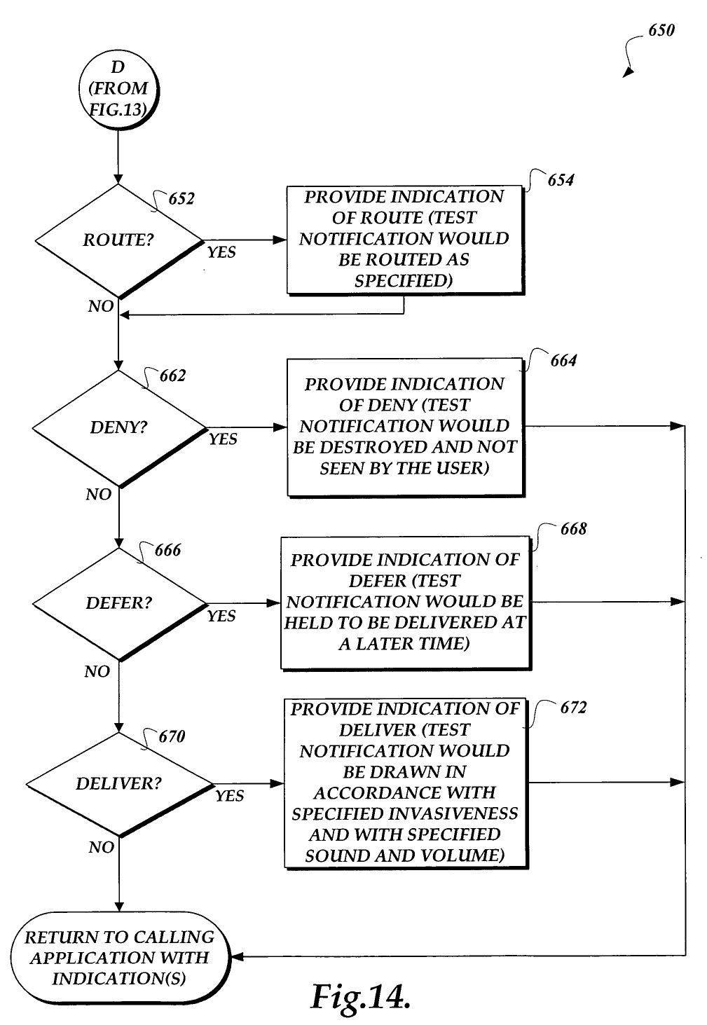

As illustrated in FIG. 13, at a block 602 the notification test API is called or a subscription is registered (as related to the polling versus subscription embodiments described above). At a decision block 610, a determination is made whether the test notification matches any user rules. If the test notification does not match any user rules, then the routine proceeds to a decision block 620, as will be described in more detail below. If the test notification does match any user rules, then the routine proceeds to a block 612. At block 612, the test notification is evaluated according to the user rules (based on the test notification content plus the user contexts), and the routine continues to a point D that is continued in FIG. 14, as will be described in more detail below.

At decision block 620, a determination is made whether the test notification would be able to draw at the present time (based on user context only). If the test notification would not be able to draw at the present time, then the routine proceeds to a decision block 630, as will be described in more detail below. If the test notification would be able to draw at the present time, then the routine proceeds to a block 622. At block 622, the routine determines what sound level would be appropriate according to the user context. At a block 624, an indication is provided that the notification would draw, and also including the percentage sound level that would be appropriate for the notification.

At decision block 630, the determination is made whether the test notification would be held for later delivery (based on the test notification content plus the user rules). If the test notification would be held for later, then the routine proceeds to a block 632 where an indication is provided of defer. If the test notification would not be held for later delivery, then the routine proceeds to a block 634, where an indication is provided of deny. From blocks 624, 632 and 634, the routine returns to the calling application with the specified indication(s).

FIG. 14 is a flow diagram illustrative of a routine 650 for evaluating a test notification in accordance with user rules. The routine continues from a point D from FIG. 13. As illustrated in FIG. 14, at a decision block 652, a determination is made whether the test notification should be routed. If the test notification is to be routed, then the routine proceeds to a block 654 where an indication of route is provided, and the routine proceeds to a decision block 662. If the test notification would not be routed, the routine also proceeds to decision block 662.

At decision block 662, a determination is made whether the test notification would be denied. If the test notification would be denied, then the routine proceeds to a block 664, where an indication of deny is provided. If the test notification would not be denied, then the routine proceeds to a decision block 666.

At decision block 666, a determination is made whether the test notification would be deferred. If the test notification would be deferred, then the routine proceeds to a block 668, where an indication is provided of defer. If the test notification would not be deferred, then the routine proceeds to a decision block 670.

At decision block 670, a determination is made whether the test notification would be delivered. If the test notification would be delivered, then the routine proceeds to a block 672, where an indication of deliver is provided. In one embodiment, the delivery indication may also include a specified invasiveness indication as well as a sound and volume indication. If the test notification would not be delivered, then the routine returns to the calling application. From blocks 664, 668, and 672, the routine returns to the calling application with the specified indications.

It will be appreciated that FIGS. 11-14 illustrate a system and method utilizing test notifications which enable programs to obtain indications as to the availability of a user. By enabling a program to have a richer view of a user's context, the generation of unwanted notifications can be prevented at the source, thus allowing notifications to only be generated when a user is in a receptive state. In addition, a program is able to utilize the test notifications to determine a user's context, even if the program generally utilizes a different user interface for its own notifications. These aspects allow for greater flexibility in the potential uses of the user context system. These aspects also enable new richer scenarios for other programs, such that the system as a whole can become richer and more intelligent based on the user's behavior and preferences.

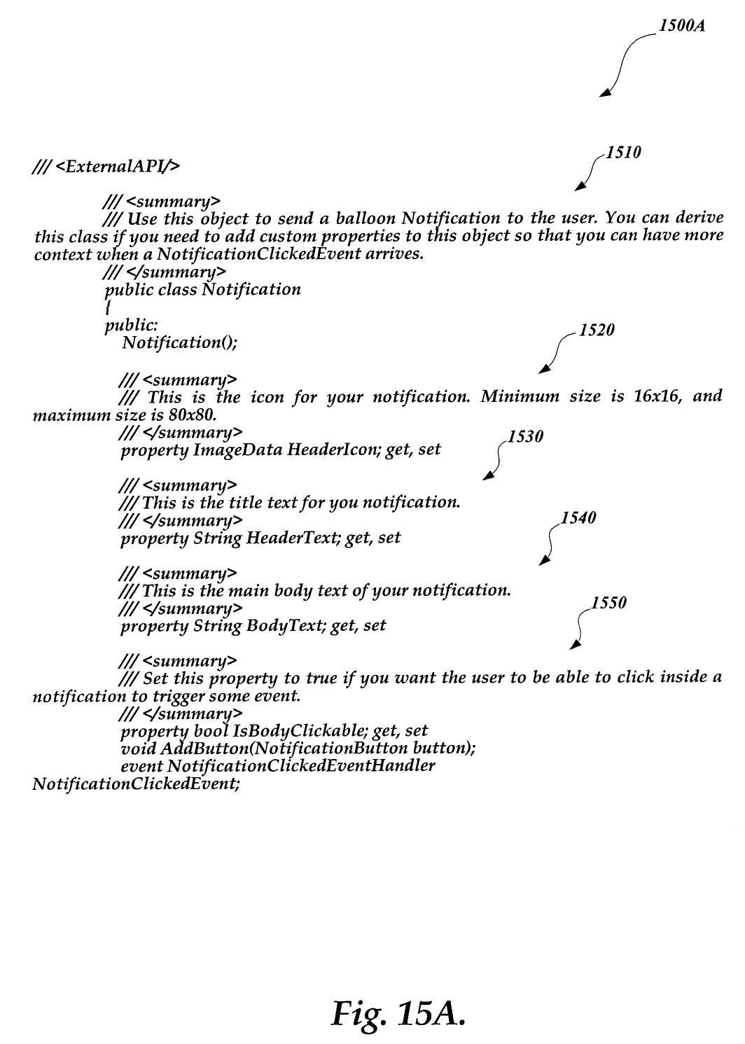

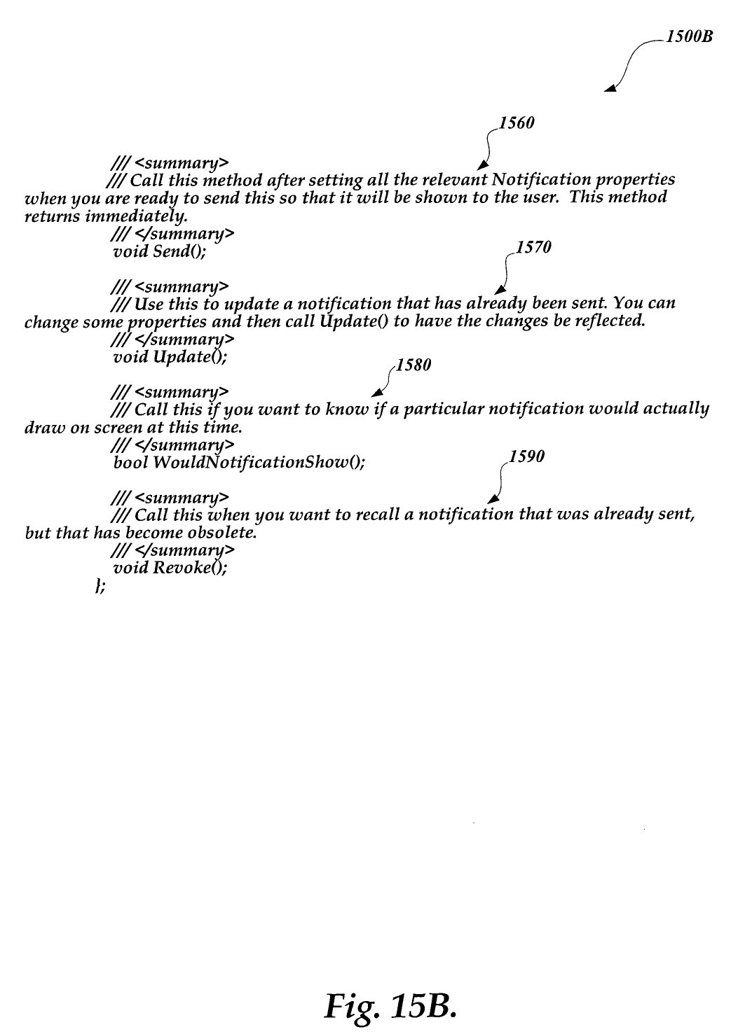

FIGS. 15A and 15B are diagrams illustrative of pseudo code 1500A and 1500B for a notifications API. As shown in FIG. 15A, the pseudo code 1500A includes portions 1510-1550. The portion 1510 relates to an object for sending a balloon notification to the user. This class can be derived if there is a need to add custom properties to the object so as to have more context when a NotificationClickedEvent arrives.

The portion 1520 relates to the icon for sending the notification. In one embodiment, minimum and maximum sizes are specified (e.g., in one example a minimum size is 16×16 and a maximum size is 80×80). The portion 1530 relates to the title text for the notification. The portion 1540 relates to the main BodyText for the notification. The portion 1550 relates to a property that should be set as True if the user is to be able to click inside the notification to trigger some event.

As shown in FIG. 15B, the continuation of the pseudo code 1500B includes portions 1560-1590. The portion 1560 relates to a method that is to be called after the setting of all the relevant notification properties when the notification is ready to be sent so that it will be shown to the user. This method returns immediately. The portion 1570 relates to updating a notification that has already been sent. After some properties are changed, the update may be called to have the changes reflected. The portion 1580 relates to a call for determining whether a particular notification would actually draw on the screen the present time. The portion 1590 relates to a call for recalling a notification that was already sent, but that has since become obsolete.

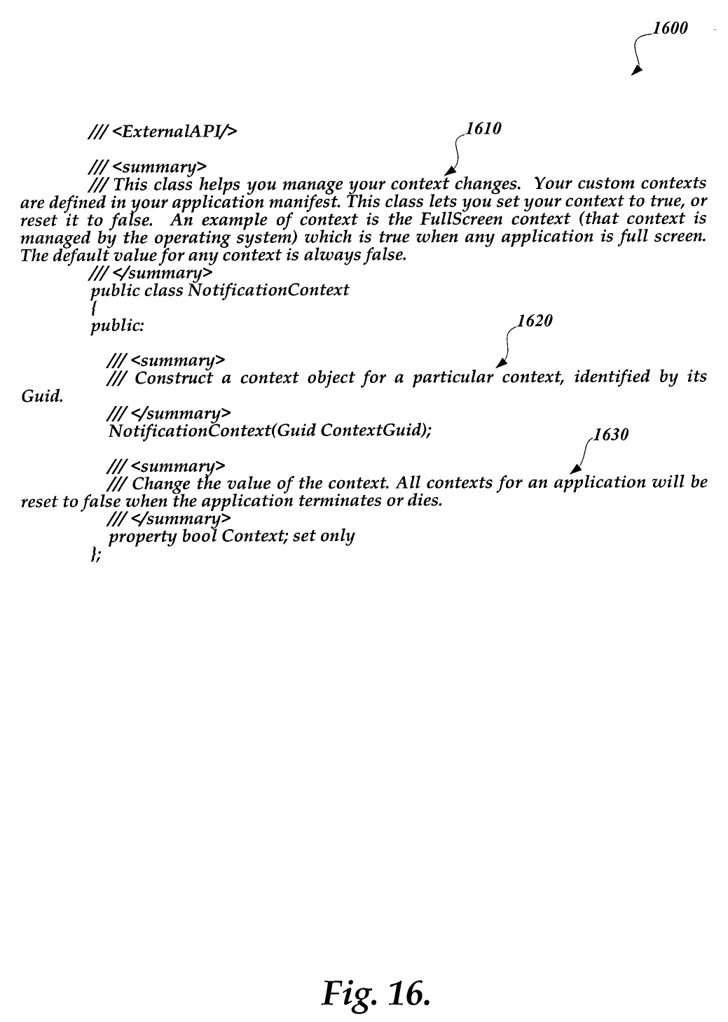

FIG. 16 is a diagram illustrative of pseudo code 1600 for a context setting API. The pseudo code 1600 includes portions 1610-1630. The portion 1610 notes that this class helps manage context changes. In one embodiment, the custom contexts are defined in an application manifest. This class allows a context to be set as True, or reset to False. An example of context is the FullScreen context (which in one embodiment is managed by the operating system) which is True when any application is full screen. In one embodiment, the default value for any context is always False. The portion 1620 relates to constructing a context object for a particular context, as identified by its GUID. The portion 1630 relates to changing the value of a context. In one embodiment, all of the contexts for an application will be reset to False when the application terminates or dies.

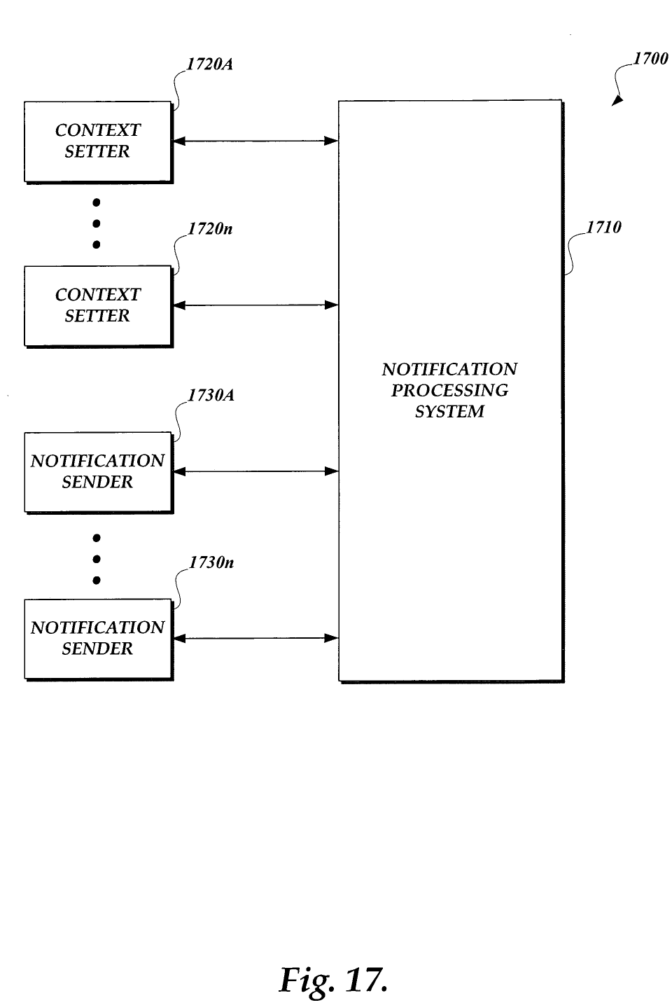

FIG. 17 is a block diagram of a notification system 1700. The notification system 1700 includes a notification processing system 1710, context setters 1720A-1720n and notification senders 1730A-1730n. As described above, the context setters 1720A-1720n communicate with the notification processing system 1710 such that a context setting API is called by which context setters declare default contexts and their impact on the user's busy state, and also set already declared contexts as true or false, which are then added to the user contexts. As also described above, the notification senders 1730A-1730n communicate with the notification processing system 1710 such that the notification API is called, and the elements of the notifications are evaluated with respect to the user contexts as set by the context setters 1720A-1720n and as further approved or modified by the user and with respect to the user rules as set by the user. Then, in accordance with the evaluation, the notifications are delivered, deferred, denied, routed or otherwise handled.

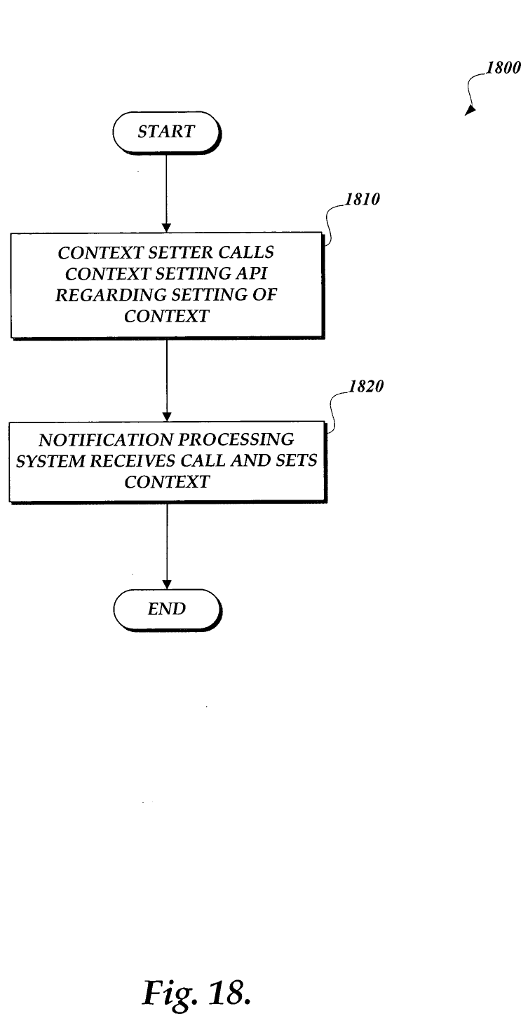

FIG. 18 is a flow diagram illustrative of a general routine 1800 by which a context setting API is called. At a block 1810, a context setter calls the context setting API regarding the setting of the context. At a block 1820, the notification processing system receives the call and the context is set. As described above, the context setters declare their default contexts and their impact on the user's busy state. The context setters set an already declared context as true or false, which are then added to the user contexts.

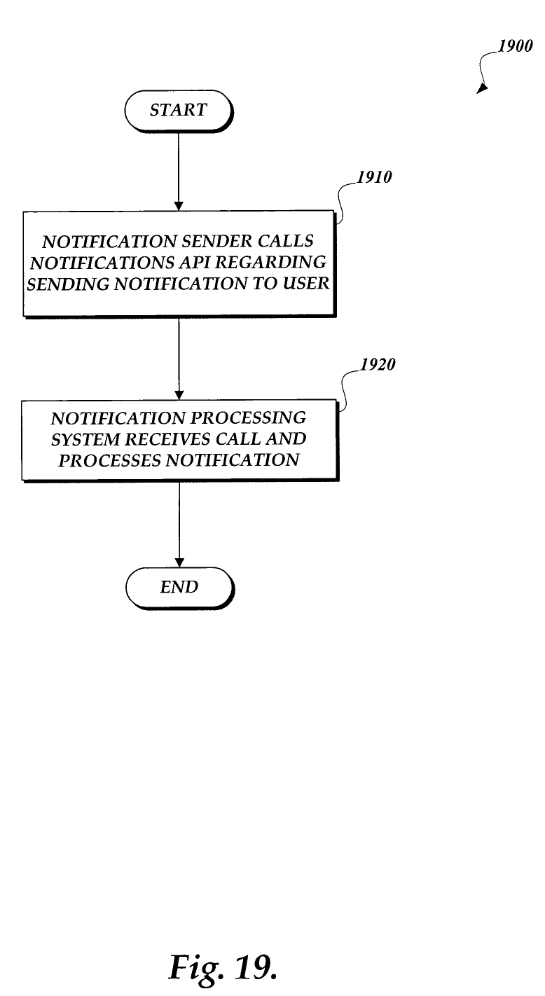

FIG. 19 is a flow diagram illustrative of a general routine 1900 by which a notification API is called. At a block 1910, a notification sender calls the notifications API regarding sending a notification to a user. At a block 1920, the notification processing system receives the call and processes the notification. As described above, once the notification API is called, the elements of the notification are evaluated with respect to the user contexts as set by the context setters and as further approved or modified by the user and with respect to the user rules as set by the user. Then, in accordance with evaluation, the notification is delivered, deferred, denied, routed or otherwise handled.

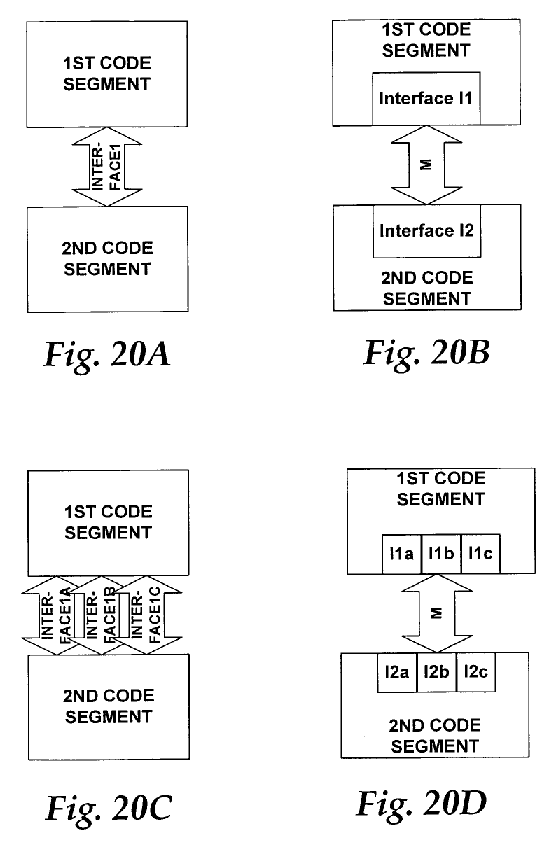

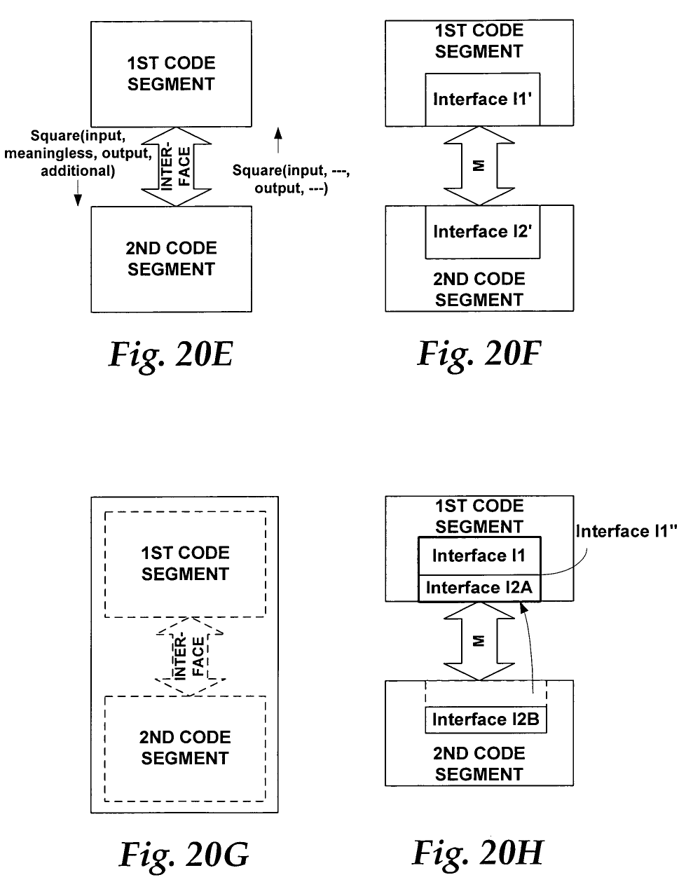

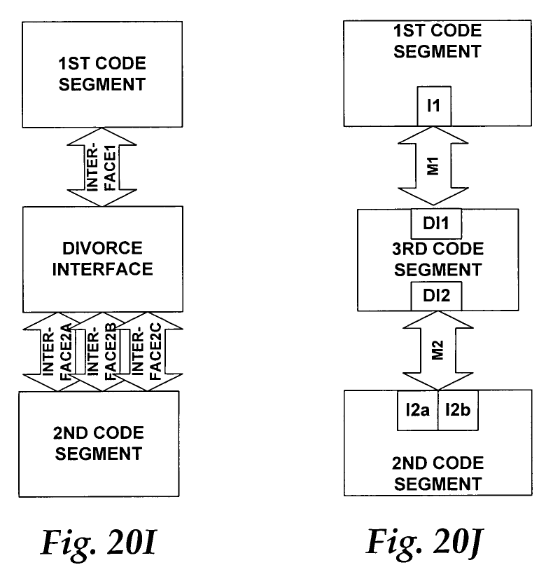

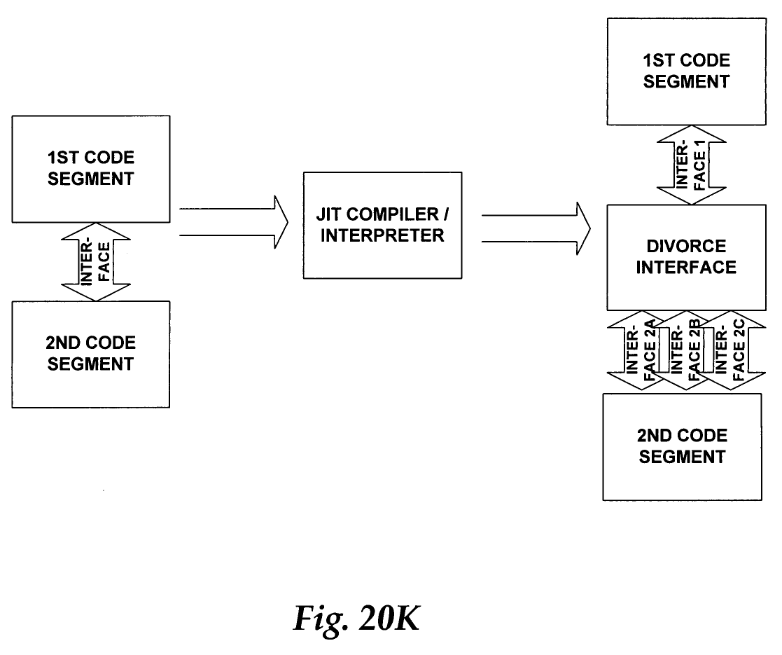

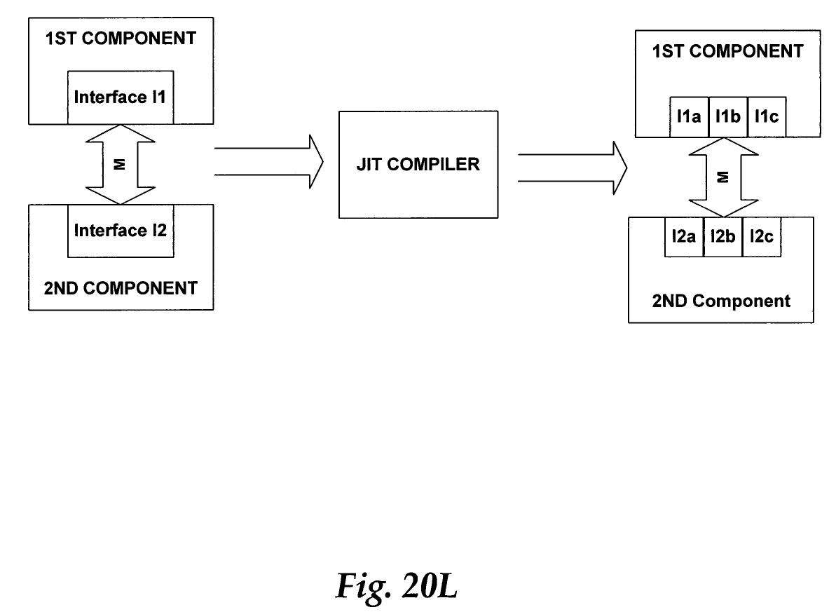

The system of the embodiment of the present invention may utilize various programming interfaces. As will be described in more detail below with respect to FIGS. 20A-20L, a programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Notionally, a programming interface may be viewed generically, as shown in FIG. 20A or FIG. 20B. FIG. 20A illustrates an interface Interface 1 as a conduit through which first and second code segments communicate. FIG. 20B illustrates an interface as comprising interface objects I1 and I2 (which may or may not be part of the first and second code segments), which enable first and second code segments of a system to communicate via medium M. In the view of FIG. 20B, one may consider interface objects I1 and I2 as separate interfaces of the same system and one may also consider that objects I1 and I2 plus medium M comprise the interface. Although FIGS. 20A and 20B show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing description. There are, however, other ways to implement a programming interface, and, unless expressly excluded, these too are intended to be encompassed by the claims set forth at the end of this specification. Such other ways may appear to be more sophisticated or complex than the simplistic view of FIGS. 20A and 20B, but they nonetheless perform a similar function to accomplish the same overall result. We will now briefly describe some illustrative alternative implementations of a programming interface.

FIGS. 20C and 20D illustrate a factoring implementation. In accordance with a factoring implementation, a communication from one code segment to another may be accomplished indirectly by breaking the communication into multiple discrete communications. This is depicted schematically in FIGS. 20C and 20D. As shown, some interfaces can be described in terms of divisible sets of functionality. Thus, the interface functionality of FIGS. 20A and 20B may be factored to achieve the same result, just as one may mathematically provide 24, or 2 times 2 time 3 times 2. Accordingly, as illustrated in FIG. 20C, the function provided by interface Interface 1 may be subdivided to convert the communications of the interface into multiple interfaces Interface 1A, Interface 1B, Interface 1C, etc. while achieving the same result. As illustrated in FIG. 20D, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 20C and 20D, the functional spirit of interfaces Interface 1 and I1 remain the same as with FIGS. 20A and 20B, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

FIGS. 20E and 20F illustrate a redefinition implementation. In accordance with a redefinition implementation, in some cases, it may be possible to ignore, add or redefine certain aspects (e.g., parameters) of a programming interface while still accomplishing the intended result. This is illustrated in FIGS. 20E and 20F. For example, assume interface Interface 1 of FIG. 20A includes a function call Square (input, precision, output), a call that includes three parameters, input, precision and output, and which is issued from the 1st Code Segment to the 2nd Code Segment. If the middle parameter precision is of no concern in a given scenario, as shown in FIG. 20E, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 20F, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, that are not needed for some purpose, and so they may be ignored or redefined, or processed elsewhere for other purposes.

FIGS. 20G and 20H illustrate an inline coding implementation. In accordance with an inline coding implementation, it may also be feasible to merge some or all of the functionality of two separate code modules such that the “interface” between them changes form. For example, the functionality of FIGS. 20A and 20B may be converted to the functionality of FIGS. 20G and 20H, respectively. In FIG. 20G, the previous 1st and 2nd Code Segments of FIG. 20A are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface 1 may still be in effect. Similarly, shown in FIG. 20H, part (or all) of interface I2 from FIG. 20B may be written inline into interface I1 to form interface I1.″ As illustrated, interface I2 is divided into I2a and I2b, and interface portion I2a has been coded in-line with interface I1 to form interface I1.″ For a concrete example, consider that the interface I1 from FIG. 20B performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

FIGS. 20I and 20J illustrate a divorce implementation. In accordance with a divorce implementation, a communication from one code segment to another may be accomplished indirectly by breaking the communication into multiple discrete communications. This is depicted schematically in FIGS. 20I and 20J. As shown in FIG. 20I, one or more piece(s) of middleware (Divorce Interface(s), since they divorce functionality and/or interface functions from the original interface) are provided to convert the communications on the first interface, Interface 1, to conform them to a different interface, in this case interfaces Interface 2A, Interface 2B and Interface 2C. This might be done, e.g., where there is an installed base of applications designed to communicate with, say, an operating system in accordance with an Interface 1 protocol, but then the operating system is changed to use a different interface, in this case interfaces Interface 2A, Interface 2B and Interface 2C. The point is that the original interface used by the 2nd Code Segment is changed such that it is no longer compatible with the interface used by the 1st Code Segment, and so an intermediary is used to make the old and new interfaces compatible. Similarly, as shown in FIG. 20J, a third code segment can be introduced with divorce interface DI1 to receive the communications from interface I1 and with divorce interface D I2 to transmit the interface functionality to, for example, interfaces I2a and I2b, redesigned to work with D I2, but to provide the same functional result. Similarly, D I1 and D I2 may work together to translate the functionality of interfaces I1 and I2 of FIG. 20B to a new operating system, while providing the same or similar functional result.

FIGS. 20K and 20L illustrate a rewriting implementation. In accordance with a rewriting implementation, yet another possible variant is to dynamically rewrite the code to replace the interface functionality with something else but which achieves the same overall result. For example, there may be a system in which a code segment presented in an intermediate language (e.g., Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1 st Code Segment to the 2nd Code Segment, i.e., to conform them to a different interface as may be required by the 2nd Code Segment (either the original or a different 2nd Code Segment). This is depicted in FIGS. 20K and 20L. As can be seen in FIG. 20K, this approach is similar to the divorce configuration described above. It might be done, e.g., where an installed base of applications are designed to communicate with an operating system in accordance with an Interface 1 protocol, but then the operating system is changed to use a different interface. The JIT Compiler could be used to conform the communications on the fly from the installed-base applications to the new interface of the operating system. As depicted in FIG. 20L, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 20A and 20B. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

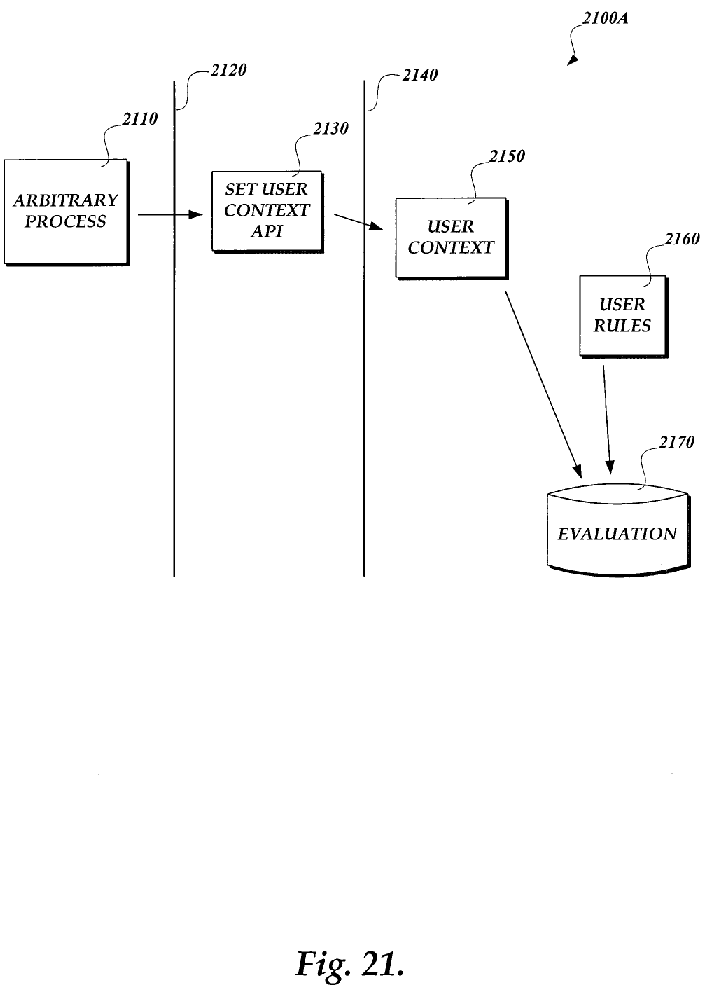

FIGS. 21-28 are directed to a system and method for public consumption of communication events between arbitrary processes. As discussed above, the notification user context system focuses on when it is appropriate or not appropriate to interrupt a user with a notification based on the user's context. As will be discussed in more detail below, notification mechanisms may be provided for a process to gain insight into when such notification events are occurring, specifically targeting communication-type events, and allowing the processes to act on these events on the user's behalf. By utilizing these mechanisms, rather than requiring a user to personally respond in real time to incoming notifications, the user may instead set a simple white list or other means of identifying people important to the user, and the mechanisms may then provide these people with insights into when the user will be more available for communication. For example, one process that might register to be informed when communication events occur could be a calendaring-type program. The calendaring-type program may have domain knowledge of the user's activities outside of the data that the notification system has (e.g., that the user is scheduled to be giving a presentation during selected times of the day). When a notification comes in and is denied because the user is currently busy, the calendaring program may be provided with a copy of the notification and the fact that it was not delivered, and can evaluate whether or not the sender of the notification is important enough to receive a customized announcement. If the sender of the notification is important enough, a customized announcement might be sent such as “the user you are trying to contact is giving a presentation right now, but if you contact him at time x, you will likely be successful as his calendar is free then.” In this scenario, it will be appreciated that the notification system is able to act to effectively broker a user's communications, and thus acts as a type of automated assistant for the user.

FIG. 21 is a diagram of a system 2100A illustrating the setting of a user context and user rules. As shown in FIG. 21, an arbitrary process 2110 communicates across process boundaries 2120 and 2140 in order to set a user context 2150. More specifically, the arbitrary process 2110 utilizes a set user context API 2130 in order to set the user context 2150. The user context 2150 and a set of user rules 2160 are provided to an evaluation component 2170, as will be described in more detail below.

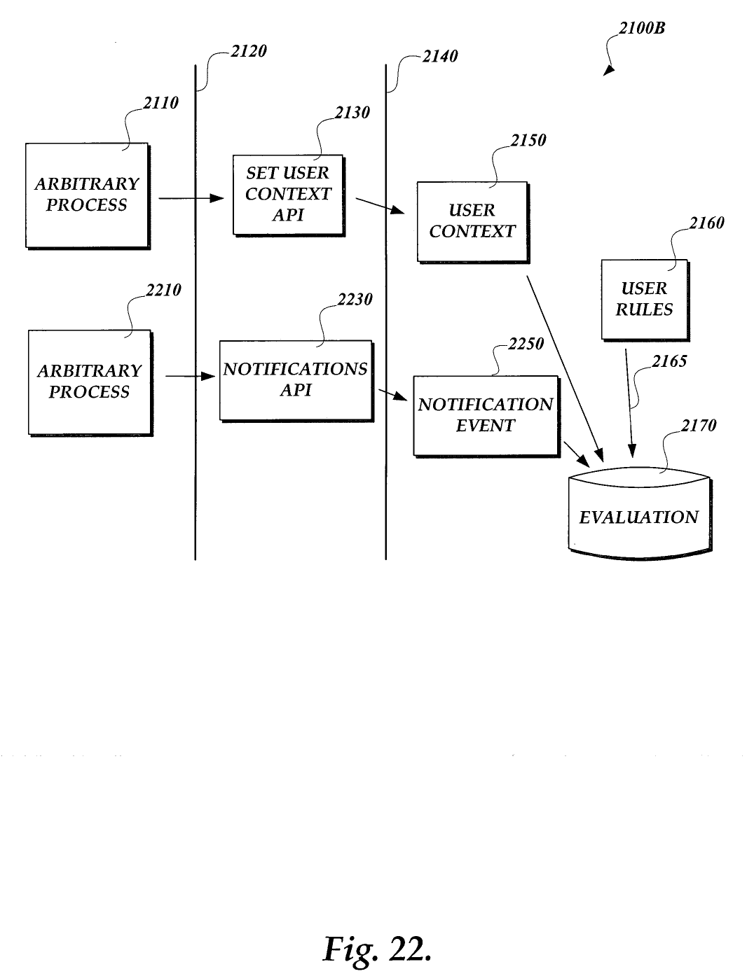

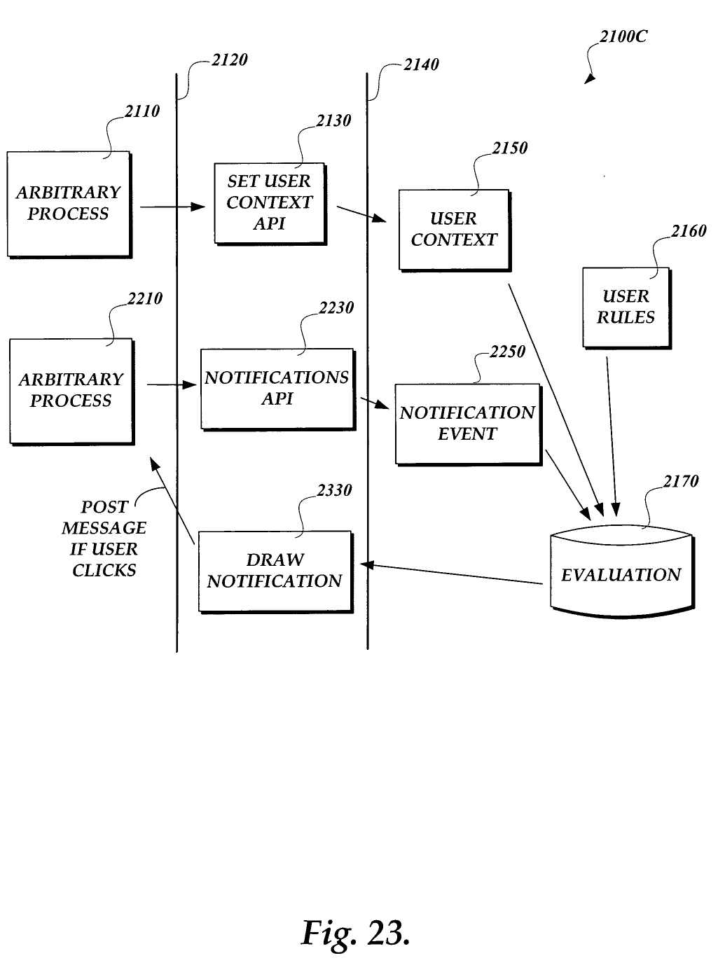

FIG. 22 is a diagram of a system 2100B illustrating the initiation of a notification event. As shown in FIG. 22, an arbitrary process 2210 utilizes a notifications API 2230 to create a notifications event 2250. For example, the arbitrary process 2210 may be sending the user a notification from another person. The arbitrary process 2210 may be any kind of communication program, such as e-mail, instant messaging, a telephone program, etc. As will be described in more detail below, the evaluation component 2170 evaluates the notification event 2250 in accordance with the user context 2150 and the user rules 2160. In one example, the evaluation component 2170 may determine that the user is busy, in which case the notification may fail. In another example, the user may not be busy, in which case the notification may be drawn, as will be described in more detail below with reference to FIG. 23.

FIG. 23 is a diagram of a system 2100C illustrating the drawing of a notification. As shown in FIG. 23, the evaluation component 2170 considers the user context 2150, the user rules 2160 and the notification event 2250, and determines that it is appropriate to draw a notification 2330. If the user then clicks on the notification, the notification message will be posted for the user.

As an example of a scenario in which a notification would not be drawn (e.g., the user is busy such that a notification fails), in one circumstance the arbitrary process 2110 may be running in full screen. The user context 2150 would thus indicate to the notification system that the user is currently not available to interruption. For example, the user may be giving a presentation or may be otherwise fully occupied such that drawing anything on the screen would currently be inappropriate. Alternatively, if the user is available, then the user context 2150 will so indicate.

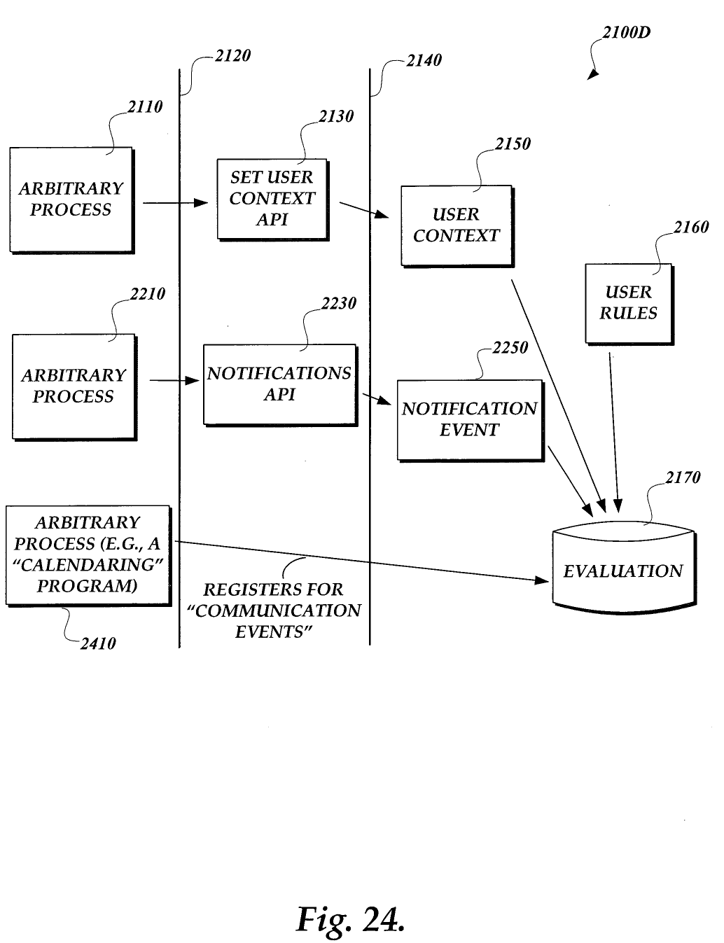

FIG. 24 is a diagram of a system 2100D illustrating a process that is registering for communication events. As shown in FIG. 24, an arbitrary process 2410 communicates with the evaluation component 2170 so as to register for communication events. In one example, the arbitrary process 2410 may be a program that has some domain knowledge of the user's activities outside of the data that the notification system has. For example, the arbitrary process 2410 might be a type of calendaring program that could have knowledge of what activities the user is currently engaged in (e.g., that the user is scheduled to be giving a presentation during selected times of the day). As will be described in more detail below, the process 2410 may thus be able to include information in any reply that it sends that may indicate what the user is currently doing, when the user will be free, and any appropriate alternate contacts that the person who initiated the communication may follow up with. For example, the busy reply may indicate that the user is more likely to be available at a time x when his calendar is free, or that certain alternate contacts may be appropriate to follow up with.

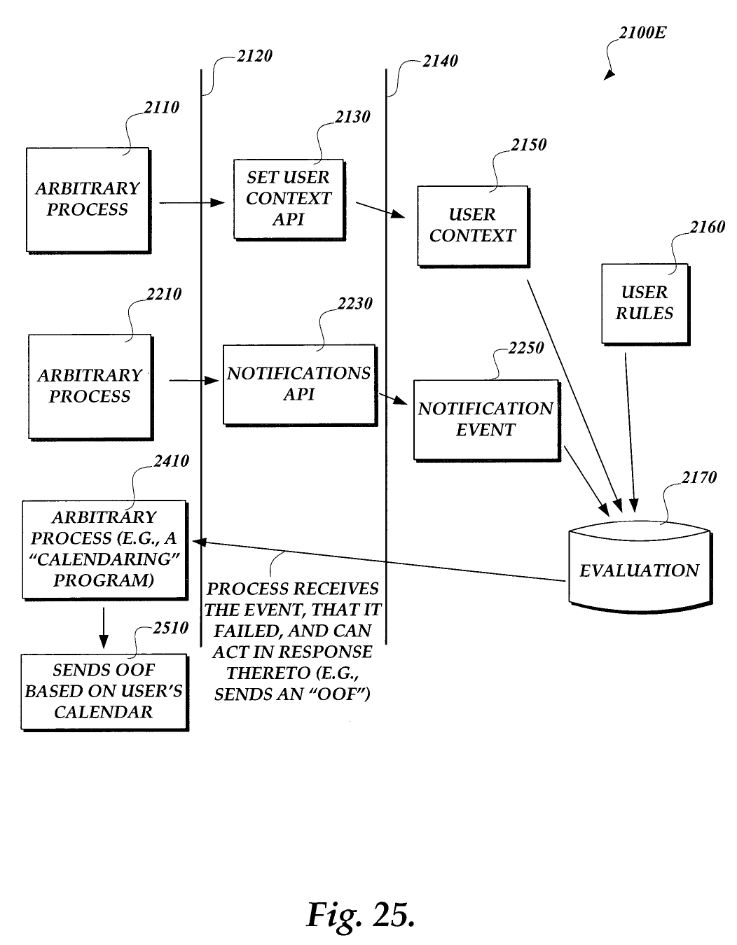

FIG. 25 is a diagram of a system 2100E illustrating a process receiving a communication event and providing a customized announcement in response thereto. As shown in FIG. 25, the evaluation component 2170 has determined that the user is busy and that the notification therefore fails. The evaluation component 2170 then provides this information, along with a copy of the notification, to the arbitrary process 2410. In response to this information, the arbitrary process 2410 sends an OOF message 2510 based on the user's calendar. More specifically, the arbitrary process 2410 has evaluated the sender of the notification (using whatever heuristics have been selected) and determined that the sender is important enough to the user to receive a customized announcement. For example, the customized busy announcement could state “the user you are trying to contact is giving a presentation right now, but if you try and contact him at time x, you will likely be successful as his calendar is free then.”

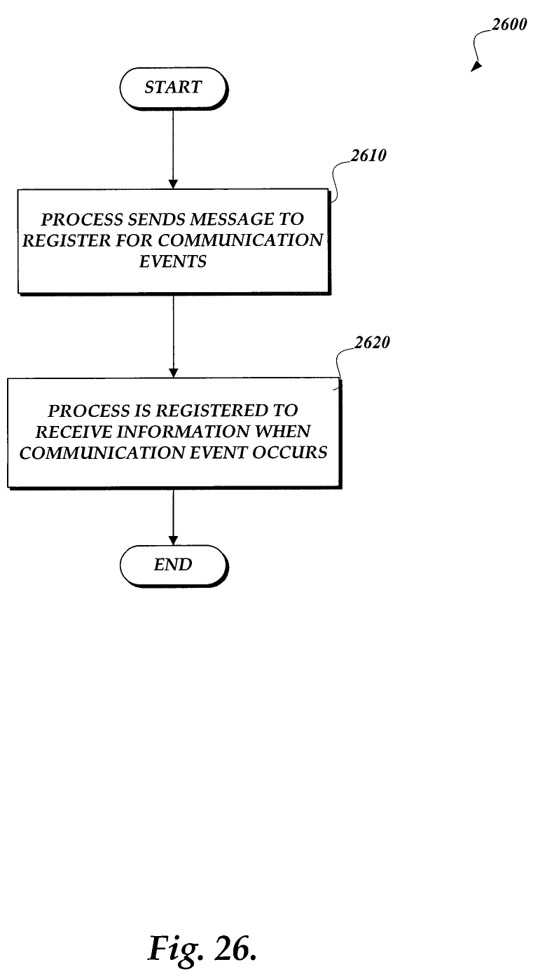

FIG. 26 is a diagram illustrative of a general routine 2600 for a process registering for communication events. At a block 2610, the process component sends a message so as to register for communication events. At a block 2620, the process is registered to receive information when communication events occur. As described above, this corresponds in FIG. 24 to the arbitrary process 2410 registering for communication events with the evaluation component 2170.

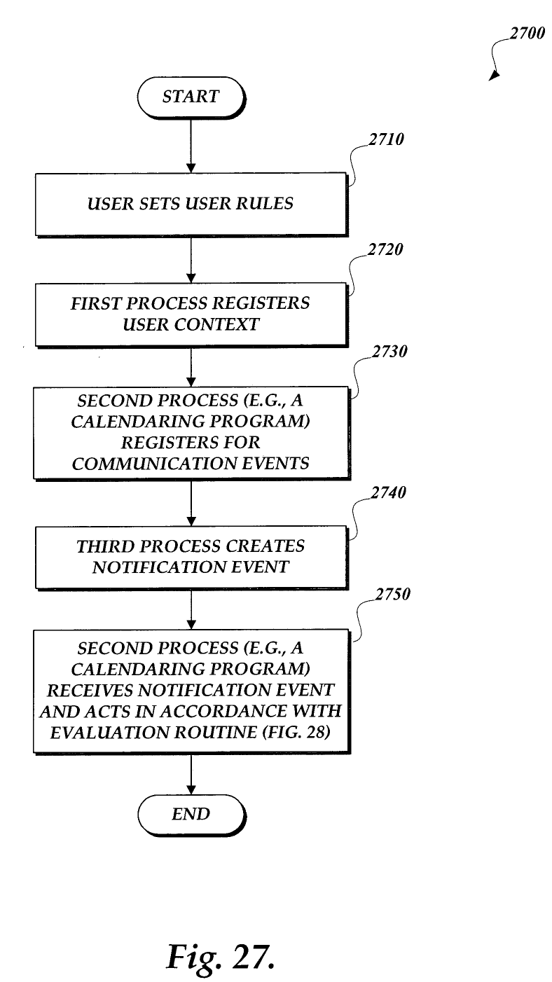

FIG. 27 is a flow diagram illustrative of a routine 2700 for a process receiving a notification event and acting in accordance with an evaluation routine. At a block 2710, the user rules are set by the user. At a block 2720, a first process registers a user context. For example, the first process may be a program that is running in full screen, which signifies to the notification system that the user is not available to interruption. In such a scenario, the user may be giving a presentation or may otherwise be fully occupied such that drawing on the screen would not currently be appropriate.

At a block 2730, a second process registers for receiving communication events. The second process in one embodiment may be a program that has some domain knowledge of the user's activities outside of the data that the notification system has. For example, the second process may be a calendaring program and may have knowledge of what activities the user is currently engaged in.

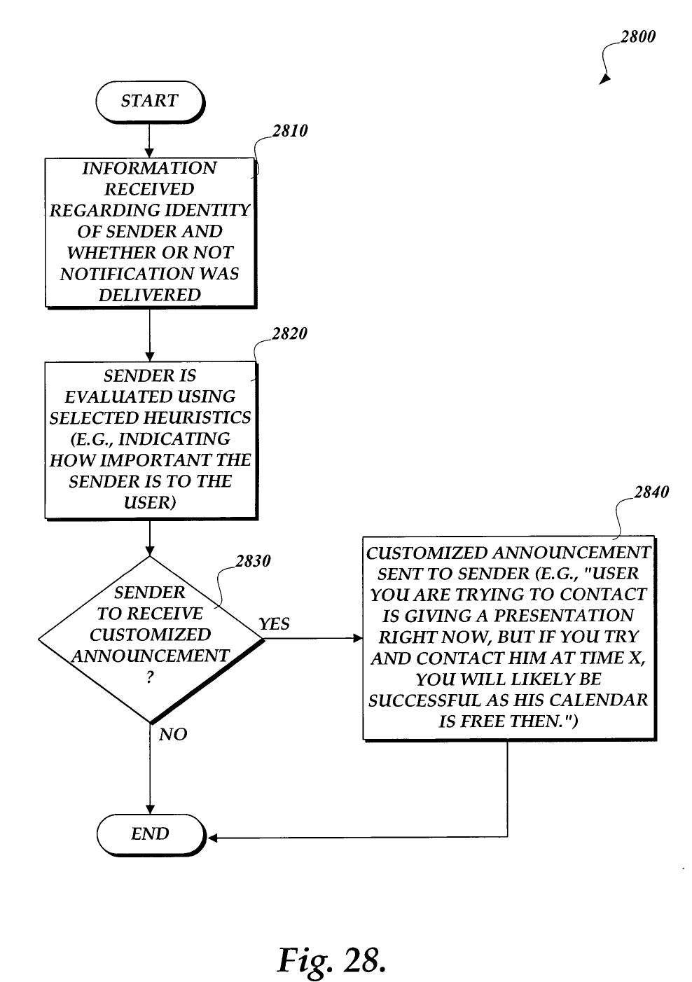

At a block 2740, a third process creates a notification event. For example, the third process may be any type of communication program, such as e-mail, instant messaging, telephone program, etc. The third process may utilize a notifications API for attempting to send the notification to the user, such that a notification event is created. At a block 2750, the second process (e.g., the calendaring program) receives the notification event and acts in accordance with an evaluation routine, as will be described in more detail below with reference to FIG. 28.

FIG. 28 is a flow diagram illustrative of a routine 2800 for a process (e.g., a calendaring program) receiving a notification event and acting in response thereto. At a block 2810, the process receives information regarding the identity of the sender of the notification and whether or not the notification was delivered. At a block 2820, the sender is evaluated using selected heuristics (e.g., which may indicate how important the sender is to the user). At a decision block 2830, a determination is made as to whether the sender satisfies the heuristic requirements (e.g., is important enough to the user) to receive a customized announcement. If the sender does not meet the requirements, then the routine ends. If the sender does meet the requirements, a customized announcement is sent (e.g., “the user you are trying to contact is giving a presentation right now, but if you try and contact him at time x, you will likely be successful as his calendar is free then”).

It will be appreciated that the elements of the system may be configured to address certain privacy concerns. For example, the system described above may be configured so as to properly broker the permissions for sending customized automated busy replies such that personal information is not revealed inappropriately. In one embodiment, the system brokers the permissions for a process to register to receive such busy replies, such that the system may not know what the arbitrary process is going to do, but the system can broker what processes can be registered and can help guide the user to understanding the implications of allowing a process to be registered. In addition, there are various possible implementations for how this new type of agent process can act on the user's behalf. For example, the process may choose to send the communication back to the communication initiator itself, or it may choose to manipulate a public object model of the process by which the communication was sent. In addition, there are various possible implementations as to the list of individuals for whom such an agent should send a busy reply. One implementation would be to send it to all individuals who initiated communication during busy times, although this may not be optimal in some embodiments. In one embodiment, a system-brokered “important people” group may be created and only communications from these people will receive the customized busy reply. In this embodiment, the process that had registered for receiving communications events may in fact only be provided with the communication event if the sender is determined to be in the group of “important people.” This would further allow the system to help broker appropriate responses on behalf of the user and to more appropriately act to help maintain the user's preferences and privacy. By having the group of “important people” be a public and system-brokered group, this helps the system in terms of overall transparency and dimensionism, which in turn makes the system more effective and easier to use.

As described above, a system and method for public consumption of communication events between arbitrary processes is provided. In accordance with one aspect, mechanisms are provided for allowing processes to obtain information regarding when notification events are occurring, and specifically targeting communication-type notification events, and allowing the processes to act on these events on the user's behalf. This functionality is provided in a notification system in which various processes provide input to the system as to how busy the user is and whether or not it is an appropriate time to interrupt the user with some secondary information (e.g., a notification), such as a communication from another person or some news generated by a Web service. In such a notification system, incoming notifications may be evaluated against rules that the user establishes such that the notifications that are delivered can be explicitly the ones most significant to the user, even during times when the system might otherwise be set in a mode where the user is indicated as being busy or otherwise unavailable to interruption.

In accordance with another aspect, a process is able to respond to the sender of a notification with information regarding the status of a user. In one example, where the process is a calendaring program, a sender of a notification may be provided with information such as that the user is busy giving a presentation at the present time but that the calendar indicates that the user will be free at a later specified time.

In accordance with another aspect, a number of processes may be utilized as part of the system and method for public consumption of communication events. Each of the processes may comprise a program that is responsible for specified functions. In the following example, three processes are described. The first process may be a program that is running a full screen, which signifies to the notification system that the user is not available to interruption. For example, the user may be giving a presentation or may be otherwise fully occupied such that it is inappropriate to attempt to interrupt the user at this time. A second process may then attempt to send a notification to the user from another person. This could be any kind of communication program (e.g., e-mail, instant messaging, a telephone program, etc.). In this circumstance, the notification system may evaluate the user's current context as “busy,” and the incoming notification would be evaluated against the user rules which may determine that the current notification should not be shown on the screen at the present time. A third process may be one that has registered to be informed when “communication” events occur. This third process is a program that has some domain knowledge of the user's activities outside of the data that the notification system has. For example, the third process may be a calendaring program that may have knowledge of what activities the user is currently engaged in (e.g., that the user is scheduled to be giving a presentation during selected times of the day). In this scenario, a copy of the notification that was sent from the second process (e.g., instant messaging) may be provided to the third process (e.g., calendaring program) along with a statement as to whether or not the notification was delivered. The third process (e.g., calendaring program) may then evaluate certain factors such as the identity of the person from which the notification originated, how important that person is to the current user (e.g., using selected heuristics), and may respond to the person who originated the notification with a customized “busy announcement” (e.g., the user you are trying to contact is doing a presentation right now, but if you try and contact him at time x, you will likely be successful, as his calendar is free then). It will be appreciated that in this scenario, the system effectively acts as a type of automated assistant for the user, and provides a mechanism by which the system may effectively act to broker a user's communications and thus provide a more effective communication system.

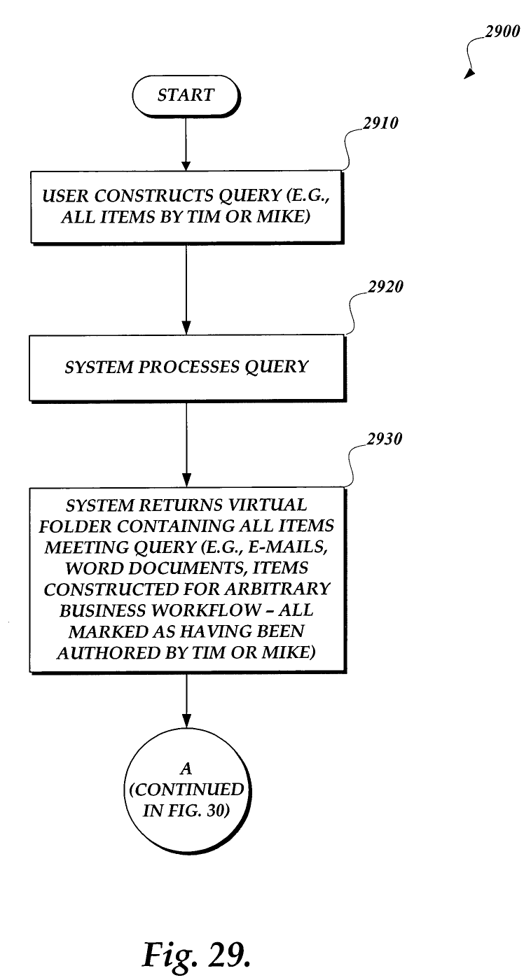

FIGS. 29-37 are directed to a system and method for a rules based engine. Certain known “rules engines” have been created for a variety of end-user activities. For example, Microsoft Outlook® has “inbox rules” that allow a user to specify a variety of actions to occur upon the reception of a given e-mail, based on characteristics of that e-mail, such as the sender or the subject line. As will be described in more detail below, the rules engine of the embodiment of the present invention provides a mechanism for a user to act on all of his or her data at once (crossing various application data types) and allows for any application willing to act in this space to provide appropriate actions, even against data that the application cannot natively consume. The rules engine allows end-users to build arbitrarily complex data sets (e.g., all items from “Tim or Mike,” with key word=“info agent or rules” with Pri>2 and edited within the last 30 days). Once these data sets have been created, the user can then set up rules to act on items conforming to the sets, so as to automate a business process or work flow (e.g., “notify me when items like this appear,” or “automatically back up these types of items to my server”).

One use of the rules engine (also referred to herein as the infoagent rules engine) is to allow the end-user, through inspecting the items within a database store, to construct arbitrarily complex queries. FIG. 29 is a flow diagram illustrative of a routine 2900 for a user to construct a query and have the system return a virtual folder containing all of the items meeting the query. At a block 2910, a user constructs a query (e.g., all items by “Tim or Mike”). The user may construct this query by inspecting the items in the database store and determining that two of the possible item authors are Tim and Mike. At a block 2920, the system processes the query. At a block 2930, the system returns a virtual folder containing all of the items meeting the query (e.g., e-mails, documents, items constructed for arbitrary business work flow—all marked as having been authored by Tim or Mike). It will be appreciated that there are numerous ways to present the results of the query through a user interface.

As noted above, a query may return a virtual folder containing all of the items meeting the query. Virtual folders are described in more detail in co-pending U.S. patent application Ser. No. 10/403,174, filed Mar. 27, 2003, which is hereby incorporated by reference in its entirety. As described in that application, virtual folders are utilized as part of a new type of file system that unifies all data into the single concept of items. Utilizing this system, users are provided with unique abilities to create over-arching rules that can traverse all of the user's data in an open and pluggable manner. In the past, various differing types of data were isolated in silos of data by application type and they generally needed to be treated in unique ways, based on the implementation of their applications. For example, e-mail was isolated from the user's documents, which was further isolated from the line of business data. In the new file system and database store, all of these data types are promoted into a single common type of “item,” with each item having appropriate per-type metadata. By bringing all of the data together into this common base item type, the end-user is given a common semantic for acting on all of the data. For example, dragging and dropping an item into a list will always result in the same action, irrespective of the underlying data type. This is advantageous for the end-user in terms of consistency and determinism when undertaking any action against any piece of data in the system. Further, because all of these items have common semantics available, it becomes much more straightforward to collect them into “sets” of data based on common characteristics. For example, a user may build a list or a folder containing both e-mail and documents. Using this system, a user may inspect the items within the database store, and determine the data type, properties they contain, and the relationship to other items within the store. The database store can also be queried to return items conforming to selected characteristics. These sets may be viewed as “folders” much like the folders one would see in other operating systems, except that these are virtual folders, with no true physical representation in the underlying data store. Thus, a virtual folder returned by a query may contain multiple types of items.

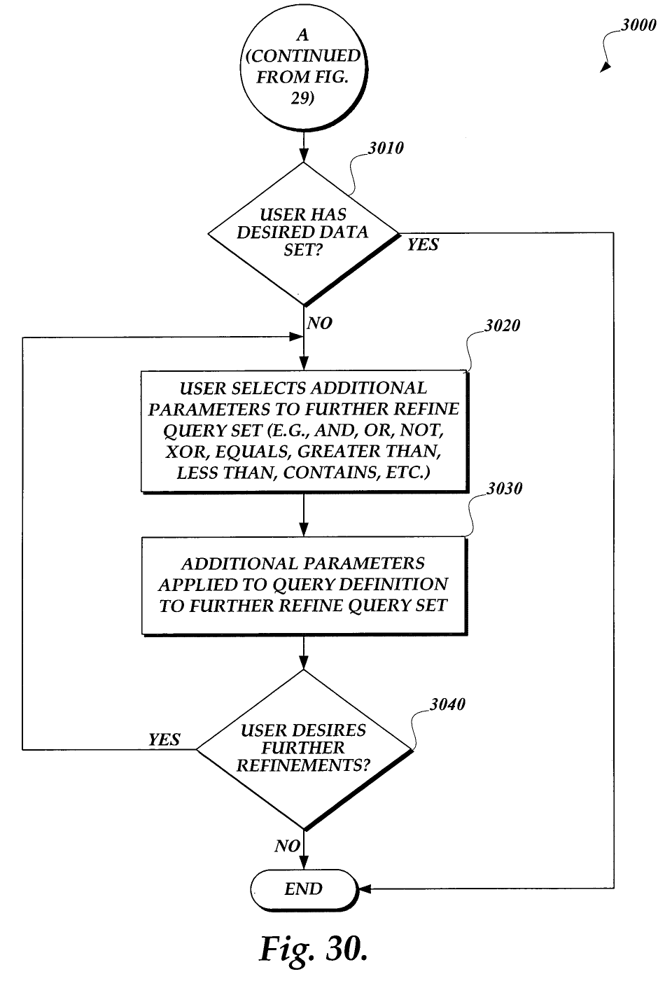

FIG. 30 is a flow diagram illustrative of a routine 3000 continuing from the routine of FIG. 29 wherein a user is able to select additional parameters for further refining a query set. In other words, if the user does not have the fully desired data set, the user may apply additional parameters to the query definition to further refine the query set. As illustrated in FIG. 30, at a decision block 3010, a determination is made as to whether the user has the desired data set. If the user does have the desired data set, then the routine ends. If the user does not have the desired data set, then the routine continues to a block 3020.

At block 3020, the user selects additional parameters to further refine the query set. It will be appreciated that these additional parameters may include any kind of logical or mathematical operations (e.g., and, or, not, xor, equals, greater than, less than, contains, etc.). At a block 3030, the additional parameters are applied to the query definition to further refine the query set. These parameters may be utilized by the user to create the exact data set desired for whatever logical, work flow, or business reasons the end-user may have in mind. At a decision block 3040, a determination is made as to whether the user desires further refinements to the data set. If the user desires further refinements, then the routine returns to block 3020. If the user does not desire further refinements, then the routine ends.

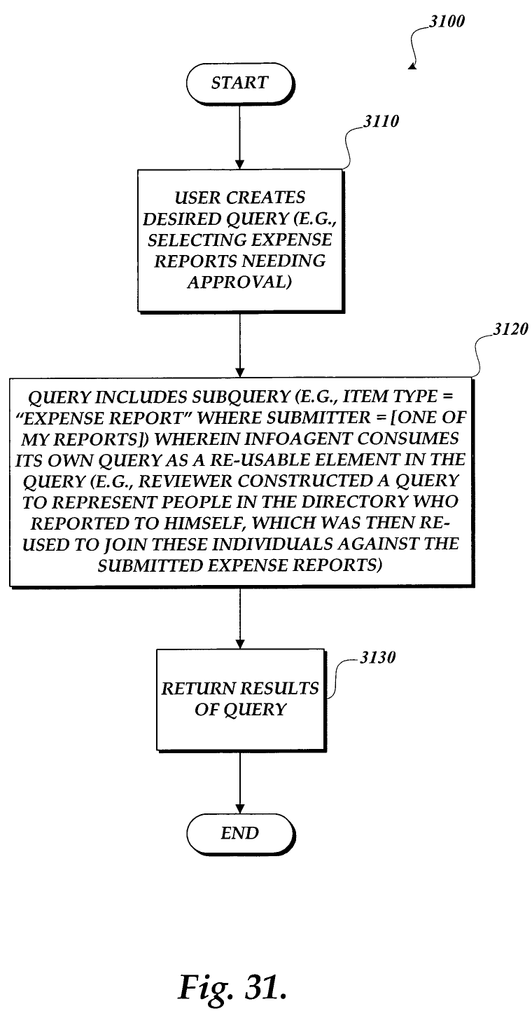

As described above, the rules engine may be utilized to construct a data set with a default action of “show me the set.” The user is able to save this query definition such that at any time subsequently, it can be rematerialized against the current state of the database store for showing those items that match the data set definition at that point in time. However, as will be described in more detail below, the rules engine is also useful as a tool for helping a user stay on top of a set of data as part of a day-to-day work flow. For example, a user may be required to implement daily tasks that involve looking at items conforming to a particular complex query set (e.g., item type=“expense report” where submitter=[one of my reports]), changing properties on these items (e.g., setting status=“approved”) and then moving the item to a common clearing place (e.g., a central server where approved expense reports are processed). In known systems, there are a variety of means by which such work flow processes might be achieved. For example, a user may e-mail the expense reports around for approval or may place the reports on a commonly accessible server share. The approver would then need to be notified in some way that a report was available that needed to be approved. The approver would then need to find the report, make whatever actions are required on it, and then remember how to move the report to its final processing point. These tasks are fairly burdensome for a user. As will be described in more detail below with respect to FIG. 31, the rules engine can be utilized to simplify this work flow.

FIG. 31 is a flow diagram illustrative of a routine 3100 for a user to create a query including a sub-query. At a block 3110, the user creates the desired query (e.g., selecting expense reports needing approval). It will be appreciated that this query will work against all items, whether the route that the report arrived through was e-mail, or through the copying of the report to a common share, etc. This occurs because all of the items in the database store are peers and the actual transport is irrelevant. At a block 3120, the query is processed. In the present case, the query includes a sub-query (e.g., item type=“expense report” where submitter=[one of my reports]). Thus, the reviewer has constructed a query to represent people in the directory who reported to himself, which was then re-used to join these individuals against the submitted expense reports. In other words, the rules engine is able to consume its own query as a re-useable element in another query. At a block 3130, the results of the query are returned.

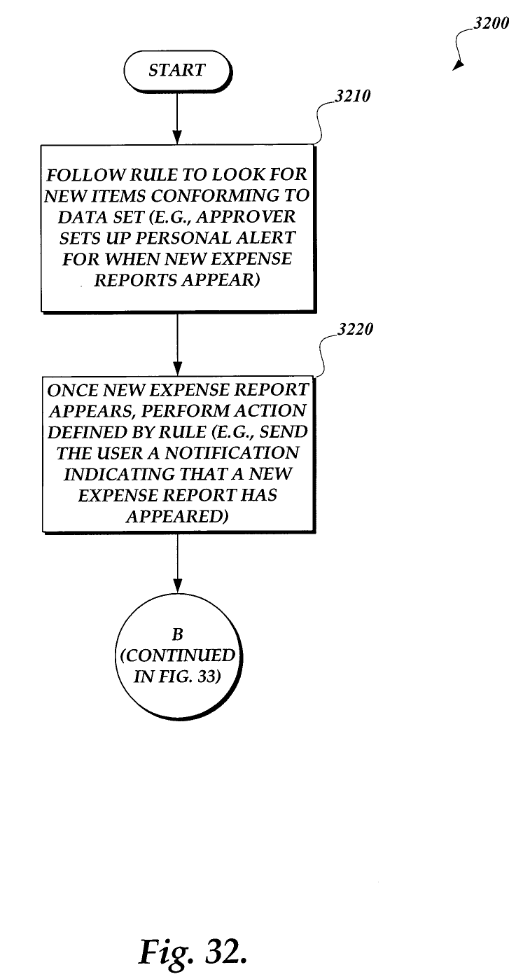

While the above process provides an approver with an easier way to find the desired items (i.e., through a single persisted query that can be re-run at will), the process to remember to go and look for these reports is still manual. However, as will be described in more detail below with reference to FIG. 32, the rules engine can be utilized to create a rule to further automate the process.

FIG. 32 is a flow diagram illustrative of a routine 3200 for following a rule to look for new items conforming to a data set, and then once a desired item is found, performing an action as defined by the rule. In a block 3210, a rule is followed to look for new items conforming to a desired data set (e.g., approver sets up a personal alert for when new expense reports appear). At a block 3220, once a new expense report appears, the action defined by the rule is performed (e.g., send the user a notification indicating that a new expense report has appeared). It will be appreciated that the notification may be sent in accordance with the notification systems described above. In one embodiment, a notification is provided in the form of an alert that is provided on the user's screen that indicates that a new expense report has appeared, however, it will be appreciated that other notification methods may also be utilized. It will also be appreciated that, as described above, the rule acts to provide the alert regardless of how the new expense report arrived, whether it was through e-mail or some other mechanism that it was moved into the database.

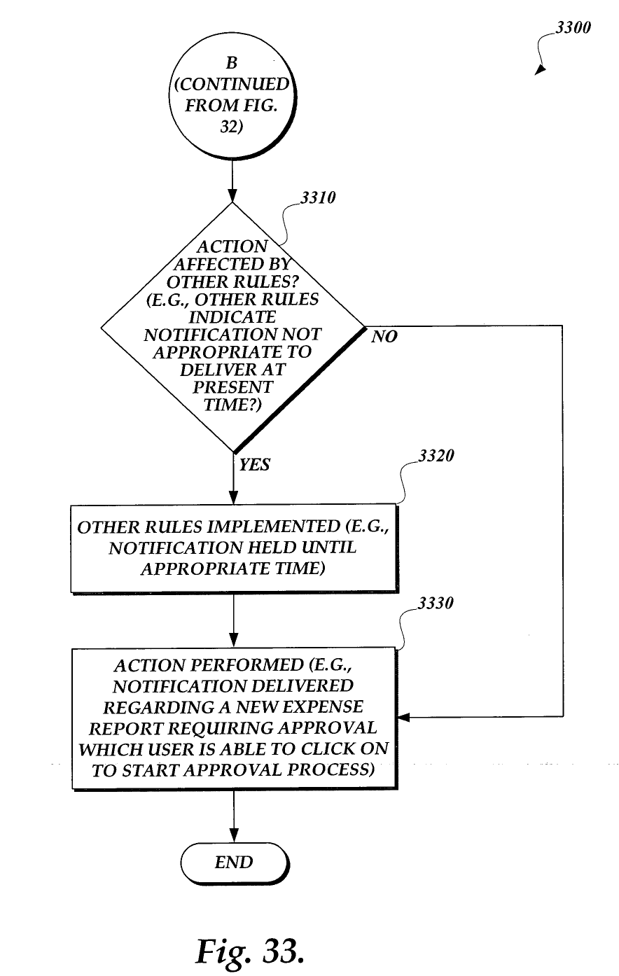

FIG. 33 is a flow diagram illustrative of a routine 3300 continuing from the routine 3200 at FIG. 32 wherein an action dictated by a rule may be modified when the action is affected by other rules. In other words, the notification engine may have additional rules about when to deliver a notification. For example, a user may be in the middle of a presentation to management. The rules engine may have rules (which in one embodiment it will by default) to not throw a notification during a full screen presentation. At a decision block 3310, a determination is made as to whether an action is affected by other rules (e.g., whether other rules indicate that a notification is not appropriate to deliver at the present time.) For example, in a case where an expense report appears and a call is made to the notification rules, these rules may process and determine that it is not an appropriate time to provide the notification to the user, and the notification may then be held until an appropriate time. At a block 3320, the notification rules are implemented (e.g., the notification is held until the appropriate time). At a block 3330, the action that is dictated by the original rule is performed (e.g., after the presentation is finished, the notification is delivered regarding a new expense report requiring approval which the user is able to click on to start the approval process).

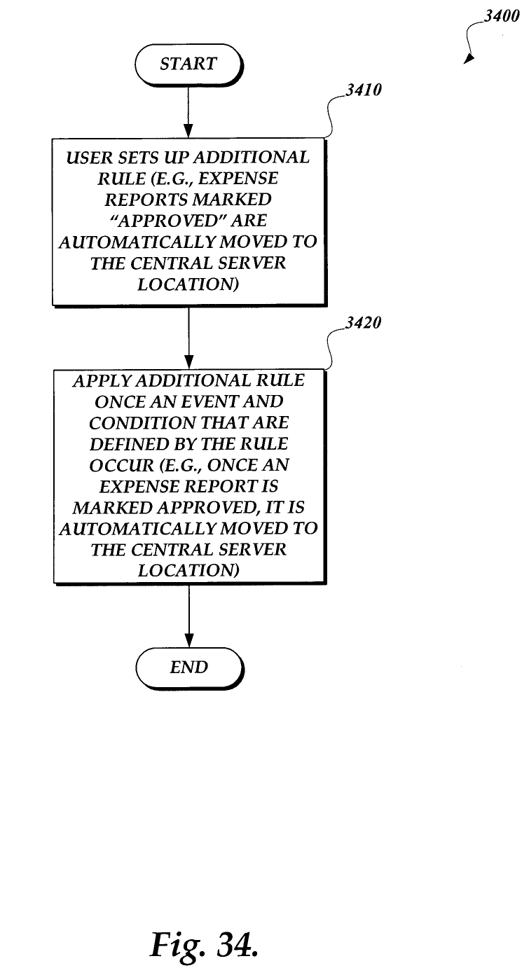

The process described above in FIG. 33 still requires certain manual steps by an approver. In other words, the approver still needs to manually set the approval metadata on the item and then do the transfer of the item (e.g., an approved expense report) to the central server for processing. However, as will be described in more detail below with reference to FIG. 34, just as the approver was able to set up a rule to notify when an item conforming to a desired set appears, the approver can go through the same process to set up another rule to further automate the process for transferring the item to the next processing point.

FIG. 34 is a flow diagram illustrative of a routine 3400 for a user to create additional rules to further automate a workflow process. In block 3410, a user sets up an additional rule (e.g., expense reports marked as “approved” are automatically moved to a central server location). The process for setting up the additional rule is similar to the process for setting up the first rule. The user first constructs a query representing the desired set (e.g., expense reports marked “approved”) and then adds an action to it (e.g., “move to central server”). At a block 3420, the additional rule is applied once an event and condition that are defined by the rule occur (e.g., once an expense report is marked approved, it is automatically moved to the central server location for further processing).

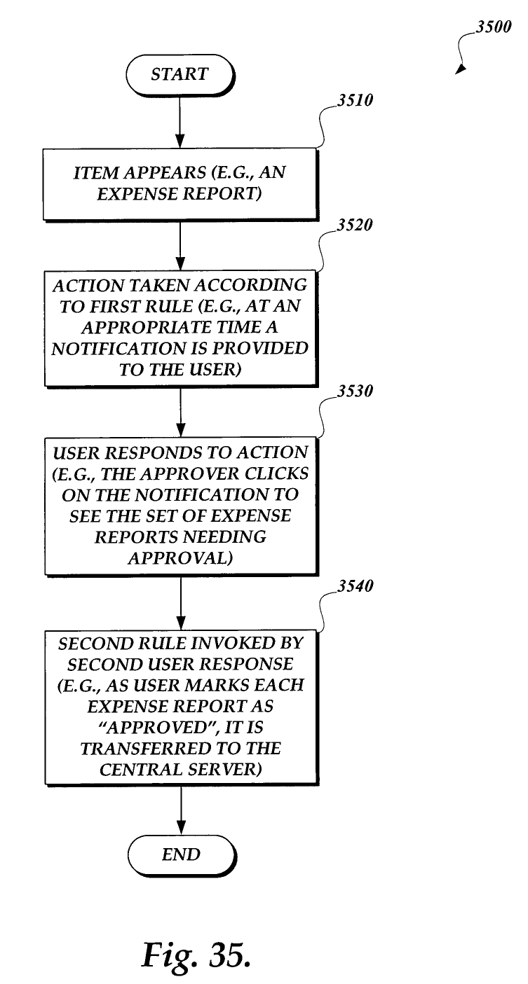

FIG. 35 is a flow diagram illustrative of a routine 3500 which represents an overall system for automating a workflow process through utilization of multiple rules. At a block 3510, an item appears (e.g., an expense report). At a block 3520, an action is taken according to a first rule (e.g., at an appropriate time when the user is not busy, a notification is provided to the user). At a block 3530, the user responds to the action (e.g., the user clicks on the notification to see the set of expense reports needing approval). At a block 3540, a second rule is invoked by a second user response (e.g., as user marks each expense report as “approved,” the expense report is transferred to the central server). It will be appreciated that the overall process of the routine 3500 allows numerous steps that previously had to be performed manually by a user to now be automated by the creation of two rules within the rules engine.

As described above, rules may comprise events, conditions and actions. In other words, a rule may state that when a specified event occurs that meets a specified condition, a specified action is performed. It will be appreciated that in some cases the conditions and events that are defined by the rules may also be empty. For example, a rule could state “for any new e-mail event, alert me.” As another example, a rule could state “for anything that causes an event in the system, alert me.”

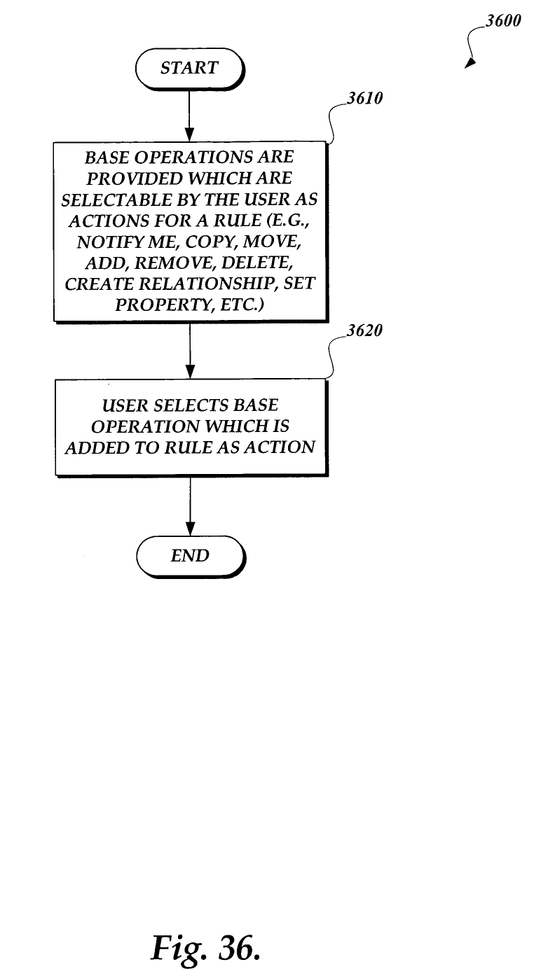

FIG. 36 is a flow diagram illustrative of a routine 3600 for providing a set of base operations from which a user may select specified actions for rules. At a block 3610, base operations are provided which are selectable by the user as actions for rules (e.g., notify me, copy, move, add, remove, delete, create relationship, set property, etc.). At a block 3620, the user selects a base operation which is added to a rule as an action. In one embodiment, the “add” and “remove” operations are used for purposes of adding or removing an additional reference to an item to a specific list. In other words, the user may have a shared list, and any time an item of a given nature appears, it can be automatically added to this list and thus shared. It will be appreciated that this provides an effective mechanism for making sure that all files pertaining to a given project are shared with specific team members.

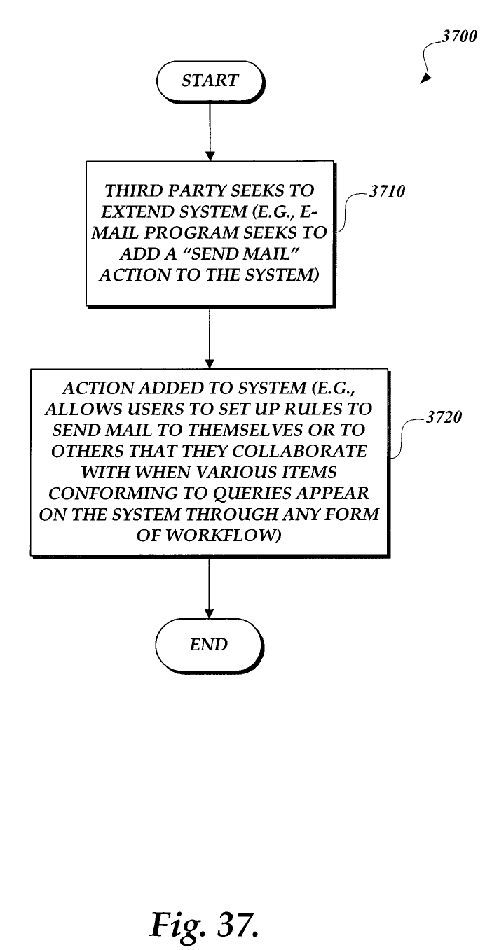

FIG. 37 is a flow diagram illustrative of a routine 3700 for a third party to add an action and thereby extend the system. At a block 3710, a third party seeks to extend the system (e.g., an e-mail program seeks to add a “send mail” action to the system). At a block 3720, the action is added to the system (e.g., allows users to set up rules to send mail to themselves or to others that they collaborate with when various items conforming to queries appear on the system through any form of workflow.). This process represents an embodiment in which the rules engine is designed such that the actions that can be taken are arbitrarily extensible by third parties who want to extend the system.

It will be appreciated that the capabilities of the rules engine may be extended to additional technologies. For example, as facial recognition technology evolves, as an individual is recognized, the rules engine could automatically create an association between that photo and the individual represented in the photo. As another example, a calendering program (e.g., Microsoft Outlook®) may know a user's schedule including the fact that they are currently in a meeting but need to reach another location after the meeting, and can monitor traffic reports, and then can send the user a notification letting them know that the highway has begun to back up, and that they will need to leave earlier in order to reach the desired location by the specified time. As another example, in a system where a user's location may be monitored according to their cell phone or other device, when a user walks far enough away from their computer, a rule may be implemented to have the computer automatically go into a security mode. As an additional example, when pictures with a date and time stamp are downloaded to a computer, a rule can be implemented to synchronize with who the user's calendar says they were meeting with during the time of the photos, and then add descriptions to the photos, and possibly forward copies to the desired users who were also participating in the activities.

While the preferred embodiment of the invention has been illustrated and described, it will be appreciated that various changes can be made therein without departing from the spirit and scope of the invention.

1. A computer-readable medium having computer-executable instructions for performing steps comprising:
defining one or more rules for acting on items which may be of different application data types, each rule comprising at least one event, condition and action; and
implementing each rule such that when a specified event occurs which satisfies the specified condition, the specified action is performed.

2. The computer-executable medium of claim 1, wherein a specified event may comprise the appearance of a new item.

3. The computer-executable medium of claim 2, wherein a condition may comprise a specified author or source of an item.

4. The computer-executable medium of claim 2, wherein an action may comprise providing a notification to a user regarding the appearance of a new item.

5. The computer-executable medium of claim 2, wherein an action may comprise moving an item to another location.

6. The computer-executable medium of claim 2, wherein the specified event is met when a new item appears regardless of the transport for the item.

7. The computer-executable medium of claim 1, wherein a rule may comprise a query for specified items.

8. The computer-executable medium of claim 7, wherein the return from the query is a virtual folder containing all of the items meeting the conditions of the query regardless of whether the items are of different application data types.

9. The computer-executable medium of claim 8, wherein the query may be further refined by a user.

10. The computer-executable medium of claim 7, wherein the query may include a sub-query which comprises a previous query that is consumed as a reusable element.

11. The computer-executable medium of claim 1, wherein after a first rule is implemented, a user's response to the first rule may invoke a second rule.

12. The computer-executable medium of claim 11, wherein the first rule comprises providing a notification to a user regarding the appearance of a new item, and the second rule comprises moving the item to a new location.

13. The computer-executable medium of claim 1, wherein an action may comprise one of copy, move, notify, add, remove, delete, create relationship, or set property.

14. The computer-executable medium of claim 13, wherein the add and remove actions may be utilized to add or remove items from a shared list.

15. The computer-executable medium of claim 1, wherein the actions for the rules may be extensible by third parties.

16. The computer-executable medium of claim 1, wherein the different application data types may comprise both e-mails and documents.

17. A computer-readable medium having computer-executable instructions for performing steps comprising:
defining parameters for building up a set of items from a common store of items which may include different item types; and
defining one or more rules for acting on items conforming to the set of items.

18. The computer-readable medium of claim 17, wherein each rule comprises an event and a condition, wherein when the event occurs that meets the condition, the rule is implemented.

19. The computer-readable medium of claim 18, wherein the rules further comprise an action, wherein when the rule is implemented, the action is performed.

20. The computer-readable medium of claim 17, wherein after a first rule is implemented, a user's response to the first rule may invoke a second rule.

21. The computer-readable medium of claim 20, wherein the first rule comprises providing a notification to a user regarding the appearance of a new item, and the second rule comprises moving the item to a new location.

22. The computer-readable medium of claim 17, wherein the actions for the rules may be extensible by third parties.

23. The computer-readable medium of claim 17, wherein the different item types may comprise both e-mails and documents.

24. The computer-readable medium of claim 17, wherein a rule may comprise a query for specified items.

25. The computer-readable medium of claim 24, wherein the return from the query is a virtual folder containing all of the items meeting the conditions of the query regardless of whether the items are of different application data types.

26. The computer-readable medium of claim 24, wherein the query may include a sub-query which comprises a previous query that is consumed as a reusable element.

27. A method for operating a rules engine in a computer system, comprising:
forming a common store of items which includes different types of items, wherein the different types of items may include both e-mails and documents; and
creating rules for acting on items, each rule specifying which items the rule will be applied to, the rule being applicable to all items regardless of whether the items are of different types.

28. The method of claim 27, wherein the rules comprise an event and a condition, wherein when an event occurs that meets the condition, the rule is implemented.

29. The method of claim 28, wherein a specified event may comprise the appearance of a new item regardless of the transport for the item.

30. The method of claim 27, wherein the rules further comprise an action, wherein when the rule is implemented, the action is performed.

31. A computer system comprising:
a common store of items which includes items of different application data types; and
a rules engine for creating rules to act on items from the common store of items, each rule being applied to each item meeting the requirements of the rule regardless of the item's application data type.

32. The system of claim 31, wherein the different application data types may comprise both e-mails and documents.

33. The system of claim 31, wherein each rule comprises at least an event, a condition, and an action.

34. The system of claim 31, wherein a rule may comprise a query for specified items.

35. The system of claim 34, wherein the return from the query is a virtual folder containing all the items meeting the conditions of the query regardless of whether the items are of different application data types.

36. The system of claim 34, wherein the query may include a sub-query which comprises a previous query that is consumed as a reusable element.

37. A computer-readable medium having computer-executable instructions for performing steps comprising:
defining one or more rules for acting with regard to items, each rule having selected criteria for the items that it will act in regard to; and
applying a rule with regard to an item once the item is determined to meet the criteria of the rule.

38. The computer-executable medium of claim 37, wherein the items include documents.

39. The computer-executable medium of claim 38, wherein the items include e-mails.

40. The computer-executable medium of claim 37, wherein the items include items that are created as part of a work flow process.
